(19) United States
(12) Patent Application Publication
(10) Pub. No.: US 2019/0052551 A1
(43) Pub. Date: Feb. 14, 2019

(54) CLOUD VERIFICATION AND TEST AUTOMATION

(71) Applicant: NOKIA SOLUTIONS AND NETWORKS OY, Espoo (FI)

(72) Inventors: Krzysztof BARCZYNSKI, Palo Alto, CA (US); Mikhael Harswanto HARSWANTO, Milpitas, CA (US); Nitin SHAH, Cupertino, CA (US); Przemyslaw SASNAL, San Jose, CA (US); Tri Wasono Adi NUGROHO, Sunnyvale, CA (US); Irving Benjamin CORDOVA, San Jose, CA (US); Zoltan SZILADI, Zurich (CH); Artur TYLOCH, Sunnyvale, CA (US); Tomasz BAK, San Jose, CA (US); Stefan Angelov PETZOV, Cupertino, CA (US)

(21) Appl. No.: 16/079,655

(22) PCT Filed: Feb. 21, 2017
(86) PCT No.: PCT/EP2017/053840

§ 371 Date: Aug. 24, 2018

Related U.S. Application Data
(60) Provisional application No. 62/300,512, filed on Feb. 26, 2016.

(51) Int. Cl. H04L 12/26; H04L 29/08; H04L 12/24

(52) U.S. Cl. CPC H04L 43/02; H04L 43/10; H04L 41/12; H04L 67/1008

(57) ABSTRACT

Various communication systems may benefit from an improved cloud verification platform. For example, a cloud verification platform that can test and verify the underlying cloud infrastructure on behalf of the cloud application in an automated and systematic fashion may be helpful. A method may include connecting to a cloud verification service for testing a cloud infrastructure. The method may also include triggering execution of a virtual network function on the cloud infrastructure. In addition, the method may include testing a key attribute of the cloud infrastructure with the executed virtual network function using the cloud verification service. Further, the method may include sending a metric of the key attribute of the cloud infrastructure or the virtual network function to a user equipment.

### CROSS REFERENCE TO RELATED APPLICATION

This application claims the benefit of and priority to U.S. Provisional Application No. 62/300,512 filed on Feb. 26, 2016, which is hereby incorporated by reference in its entirety.

### BACKGROUND

### Field

Various communication systems may benefit from improved cloud infrastructure testing. For example, a cloud verification platform that can test and verify the cloud infrastructure on behalf of an application executed on the cloud in an automated and systematic fashion may be helpful.

### Description of the Related Art

Cloud computing systems have become of increasing importance in the age of information technology. Cloud computing is an established and mature technology that may be used to run many types of applications in many different industries. In telecommunication networks, however, cloud computing is still an emerging technology, which promises to play an important role in the continuing evolution of telecommunication networks.

The development of tools and services to support the deployment of telecommunication applications on a cloud computing infrastructure is not well established. Cloud computing infrastructure is flexible yet complex, having hardware, operation systems, hypervisors, containers, applications, and services all operating together to support the functioning of the cloud. Despite the flexibility of the cloud computer infrastructure, the performance and interplay of the infrastructure and applications run on the infrastructure can be variable and unpredictable. Software applications run on the cloud computing infrastructure may therefore at times not perform as expected.

This unpredictability can cause various problems in telecommunication applications, some of which have stringent requirements, such as precise latency and bandwidth needs for networking. In order to successfully deploy a telecommunication application on a cloud computing infrastructure, the infrastructure must first be tested for operation, reliability, and performance. Given the dynamic and variable nature of cloud behavior, it may be difficult and time-consuming to test the execution of these applications on the cloud infrastructure.

Attempting to deploy multiple telecommunication applications on the cloud computing infrastructure can compound this problem. Each of the applications may have different workload, computing, storage, and networking requirements that they impose on the cloud. The cost and time of testing cloud infrastructure can be great, especially when statistically significant amounts of data have to be collected to provide accurate measurements.

### SUMMARY

A method may include connecting to a cloud verification service for testing a cloud infrastructure. The method may also include triggering execution of a virtual network function on the cloud infrastructure. A key attribute of the cloud infrastructure is tested with the executed virtual network function using the cloud verification service. In addition, the method may include receiving a metric of the key attribute of the cloud infrastructure or the virtual network function at a user equipment.

According to certain embodiments, an apparatus may include at least one memory including computer program code, and at least one processor. The at least one memory and the computer program code may be configured, with the at least one processor, at least to connect to a cloud verification service for testing a cloud infrastructure. The at least one memory and the computer program code may also be configured, with the at least one processor, at least to trigger execution of a virtual network function on the cloud infrastructure. A key attribute of the cloud infrastructure is tested with the executed virtual network function using the cloud verification service. In addition, the at least one memory and the computer program code may be configured, with the at least one processor, at least to receive a metric of the key attribute of the cloud infrastructure or the virtual network function at a user equipment.

An apparatus, in certain embodiments, may include means for connecting to a cloud verification service for testing a cloud infrastructure. The apparatus may also include means for triggering execution of a virtual network function on the cloud infrastructure. A key attribute of the cloud infrastructure is tested with the executed virtual network function using the cloud verification service. In addition, the method may include receiving a metric of the key attribute of the cloud infrastructure or the virtual network function at a user equipment.

According to certain embodiments, a non-transitory computer-readable medium encoding instructions that, when executed in hardware, perform a process. The process may include connecting to a cloud verification service for testing a cloud infrastructure. The process may also include triggering execution of a virtual network function on the cloud infrastructure. A key attribute of the cloud infrastructure is tested with the executed virtual network function using the cloud verification service. In addition, the process may include receiving a metric of the key attribute of the cloud infrastructure or the virtual network function at a user equipment.

According to certain embodiments, a computer program product encoding instructions for performing a process according to a method including connecting to a cloud verification service for testing a cloud infrastructure. The method may also include triggering execution of a virtual network function on the cloud infrastructure. A key attribute of the cloud infrastructure is tested with the executed virtual network function using the cloud verification service. In addition, the method may include receiving a metric of the key attribute of the cloud infrastructure or the virtual network function at a user equipment.

A method may include connecting to a cloud verification service for testing a cloud infrastructure. The method may also include scheduling the testing of a key attribute of the cloud infrastructure by a platform device. A virtual network function may be executed on the cloud infrastructure. In addition, the method can include sending the schedule to a test agent. Further, the method may include receiving a metric of the key attribute of the cloud infrastructure or the virtual network function.

According to certain embodiments, an apparatus may include at least one memory including computer program code, and at least one processor. The at least one memory and the computer program code may be configured, with the at least one processor, at least to connect to a cloud verification service for testing a cloud infrastructure. The at least one memory and the computer program code may also be configured, with the at least one processor, at least to schedule the testing of a key attribute of the cloud infrastructure by a platform device. A virtual network function may be executed on the cloud infrastructure. In addition, the at least one memory and the computer program code may also be configured, with the at least one processor, at least to send the schedule to a test agent. Further, the at least one memory and the computer program code may be configured, with the at least one processor, at least to receive a metric of the key attribute of the cloud infrastructure or the virtual network function.

An apparatus, in certain embodiments, may include means for connecting to a cloud verification service for testing a cloud infrastructure. The apparatus may also include means for scheduling the testing of a key attribute of the cloud infrastructure by a platform device. A virtual network function may be executed on the cloud infrastructure. In addition, the apparatus may means for sending the schedule to a test agent. Further, the method may include means for receiving a metric of the key attribute of the cloud infrastructure or the virtual network function.

According to certain embodiments, a non-transitory computer-readable medium encoding instructions that, when executed in hardware, perform a process. The process may include connecting to a cloud verification service for testing a cloud infrastructure. The process may also include scheduling the testing of a key attribute of the cloud infrastructure by a platform device. A virtual network function may be executed on the cloud infrastructure. In addition, the process may include sending the schedule to a test agent. Further, the process may include receiving a metric of the key attribute of the cloud infrastructure or the virtual network function.

According to certain embodiments, a computer program product encoding instructions for performing a process according to a method including connecting to a cloud verification service for testing a cloud infrastructure. The method may also include scheduling the testing of a key attribute of the cloud infrastructure by a platform device. A virtual network function may be executed on the cloud infrastructure. In addition, the method includes sending the schedule to a test agent. Further, the method may include receiving a metric of the key attribute of the cloud infrastructure or the virtual network function.

A method may include receiving a request from a platform device to test for a key attribute of a cloud infrastructure. A virtual network function may be executed on the cloud infrastructure. The method may also testing for the key attribute of the cloud infrastructure and the virtual network function. In addition, the method can include sending a metric of the key attribute of the cloud infrastructure or the virtual network function to the platform device.

According to certain embodiments, an apparatus may include at least one memory including computer program code, and at least one processor. The at least one memory and the computer program code may be configured, with the at least one processor, at least to receive a request from a platform device to test for a key attribute of a cloud infrastructure. A virtual network function may be executed on the cloud infrastructure. The at least one memory and the computer program code may also be configured, with the at least one processor, at least to test for the key attribute of the cloud infrastructure and the virtual network function. In addition, the at least one memory and the computer program code may also be configured, with the at least one processor, at least to send a metric of the key attribute of the cloud infrastructure or the virtual network function to the platform device.

An apparatus, in certain embodiments, may include means receiving a request from a platform device to test for a key attribute of a cloud infrastructure. A virtual network function may be executed on the cloud infrastructure. The apparatus may also include means for testing for the key attribute of the cloud infrastructure and the virtual network function. In addition, the apparatus may means for sending a metric of the key attribute of the cloud infrastructure or the virtual network function to the platform device.

According to certain embodiments, a non-transitory computer-readable medium encoding instructions that, when executed in hardware, perform a process. The process may include receiving a request from a platform device to test for a key attribute of a cloud infrastructure. A virtual network function may be executed on the cloud infrastructure. The process may also include testing for the key attribute of the cloud infrastructure and the virtual network function. In addition, the process may include sending a metric of the key attribute of the cloud infrastructure or the virtual network function to the platform device.

According to certain embodiments, a computer program product encoding instructions for performing a process according to a method including receiving a request from a platform device to test for a key attribute of a cloud infrastructure. A virtual network function may be executed on the cloud infrastructure. The method may also include testing for the key attribute of the cloud infrastructure and the virtual network function. In addition, the method may include sending a metric of the key attribute of the cloud infrastructure or the virtual network function to the platform device.

### BRIEF DESCRIPTION OF THE DRAWINGS

For proper understanding of the invention, reference should be made to the accompanying drawings, wherein:

FIG. 1 illustrates a system architecture according to certain embodiments.

FIG. 2 illustrates a flow diagram according to certain embodiments.

FIG. 3 illustrates a flow diagram according to certain embodiments.

FIG. 4 illustrates a system architecture according to certain embodiments.

FIG. 5 illustrates a system architecture according to certain embodiments.

FIG. 6 illustrates a user interface according to certain embodiments.

FIG. 7 illustrates a flow diagram according to certain embodiments.

FIG. 8 illustrates a flow diagram according to certain embodiments.

FIG. 9A illustrates a topology according to certain embodiments.

FIG. 9B illustrates a topology diagram according to certain embodiments.

FIG. 9C illustrates a topology according to certain embodiments.

FIG. 10 illustrates a flow diagram according to certain embodiments.

FIG. 11 illustrates a system architecture according to certain embodiments.

FIG. 12 illustrates a flow diagram according to certain embodiments.

FIG. 13 illustrates a flow diagram according to certain embodiments.

FIG. 14 illustrates a user interface according to certain embodiments.

FIG. 15 illustrates a user interface according to certain embodiments.

FIG. 16 illustrates a flow diagram according to certain embodiments.

FIG. 17 illustrates a flow diagram according to certain embodiments.

FIG. 18 illustrates a flow diagram according to certain embodiments.

FIG. 19A illustrates a flow diagram according to certain embodiments.

FIG. 19B illustrates a flow diagram according to certain embodiments.

FIG. 20 illustrates a system according to certain embodiments.

### DETAILED DESCRIPTION

Certain embodiments provide a consistent test that allows for analysis of the performance of a telecommunication application run on a cloud infrastructure. The test may be reproduced for various telecommunications applications so that tests can be compared to one another.

Certain embodiments may also benefit global services organizations, such as systems integration, network planning and optimization, and care services. Product development organizations that are developing applications to run on the cloud computing infrastructure may also benefit. Some embodiments apply to network core and radio access network (RAN) products, including, for example, IMS, TAS, mobility management entity, EPC, Flexi-NG, and Cloud RAN. Other products that rely on a stable, high performance hardware and software platform in order to meet their performance requirements may also benefit.

A method for testing and automation may be used to assess the performance of a cloud environment in a given mode that may allow the application to be tested as if it were being serviced by the cloud infrastructure in the real world. This mode may be known as a service mode. In certain embodiments, tests in multiple clouds may be orchestrated from a single logical service. The multiple clouds may be varied. Some embodiments involve clouds with variable internet access, or even without internet access, or internet access through a proxy.

Certain embodiments may provide for an automated selection and reassignment of services test nodes to the cloud, based on their availability and ability to connect to a particular cloud. Since some cloud environment may contain firewalls, certain embodiments can allow a service to discover which node has connection to the cloud. Some given connections may not be blocked by the firewall, and those connections can be selected for running tests in an automated fashion.

The testing may be used to optimize the deployment of a cloud by running a multitude of iterations with different configurations and factors. The results of the testing may allow for determining the optimal cloud configuration for performance and costs.

In some embodiments, the provisioning test environments may be independent of the type of cloud. In other words, the test environment may have a single test definition which may apply across various cloud types. The single test definition may allow for testing across the various cloud types to be consistent, even if the different cloud types use different ways to refer to configuration of the virtual instance to be launched.

Other embodiments may run tests in a cloud environment even when only some

Internet Protocol (IP) addresses can be used from the pool assigned to the cloud by the dynamic host configuration protocol. Yet in other embodiments, virtual machines that may not have access to cloud services may use proxy requests in order to access cloud services. In certain embodiments, the virtual machines may run the cloud service tests from within the cloud.

The tests results across clouds can be compared in an automated fashion. The test results may be used to grade the cloud performance. In some embodiments, the grading may be adjusted according to an automated threshold based on the multiple test results. In other embodiments, a flexible mechanism may be provided for new test plugins on-boarding. The plugin addition may be simplified by allowing virtual network function teams to contribute new plugins faster than traditional products. A report may be generated that includes an assessment of the cloud infrastructure assets, along with any recommendations on possible risks or gaps involved with the cloud infrastructure.

Certain embodiments also include a method for creating a platform that tests spanning the available cloud services, and the networking, compute, and storage metrics with a portfolio of automated test vectors. In some embodiments, the portfolio may include over a thousand automated test vectors. A cloud computing verification service may also be created that includes tests of the active performance of networking, computing, and storage in zones of the cloud that are allocated for telecom software.

In some embodiments, the cloud testing may be launched, run, and monitored in a large number of simultaneous tests on a single or multi-tenant environment. The results may be presented in a visual form to speed the understanding of the detailed measurements and analysis. A user interface may be created to allow viewing of the measurements and analysis, and presented to a viewer in the form of a chart, table, graph, or any other visual form that will allow a viewer to understand the analysis.

Some tests may help to assess the performance of cloud infrastructure and virtualized applications. The assessment may include checking the cloud computing infrastructure to ensure minimum performance requirements for virtualized network function application software products. The testing can emulate a workload that is representative of telecommunications software application to assess the performance of running the application in the cloud infrastructure. This emulation can allow for a virtual simulation of a real world scenario in which the application interacts with the cloud infrastructure.

Certain embodiments involve testing network performance of the transport of different protocols, such as transmission control protocol (TCP), user datagram protocol (UDP), and stream control transmission protocol (SCTP), between virtual machines. The range packet sizes transported within one virtual switch or across virtual switch boundaries may be used to benchmark the cloud during testing, and compare the results with a referenced requirement. The requirements, in some embodiments, may be predetermined. A Black Hashing algorithm may be used in certain embodiments to test computational power of the cloud infrastructure.

Alternatively, some embodiments may involve testing network performance of transport of different protocols, such as TCP, UDP, and SCTP, between virtual machines and an external gateway boundary. The network performance can be used as a benchmark for the cloud being tested, and results may then be compared with referenced requirement.

The above discussed testing embodiments may allow for the continuous testing of applications at the design and development phase of the application. The testing may therefore be used to verify the match between the full functionality of the application and the minimum performance requirements of the cloud infrastructure, which may be needed for the application to properly function.

Certain embodiments may apply machine and deep learning to the data collected from the cloud testing of the infrastructure. Benchmarks and key performance indicators (KPIs) may be stored for comparative application testing. The system may utilize machine learning to provide complex correlations and indications of deviations, anomalies, and normal behavior of the cloud. The data collected can be compared to previous tests of the same infrastructure, as well as tests from other clouds for comparison. The previous data used for comparison may be from a single test, or may be accumulated over multiple sequential or parallel tests, which may improve the statistical validity of the previous tests. The test may also capture certain time and context-variant characteristics of the cloud and its behavior.

Real-time and subsequent analysis of the data collected from the cloud testing can also occur. Certain embodiments may also be used to predict trends and future anomalies, or certain parameters that may need to be monitored based on future potential conditions that may cause functional or performance problems at the cloud infrastructure or at the applications level.

In some embodiments, an assessment of the correct functioning of security measures that have been put in place in the cloud may be performed. The presence and validated functionality of the security features can be performed, and a report generated. The cloud may also be tested for security threats, such as distributed denial of service and phishing, by an automated threat attack to assess the resilience and robustness of the cloud to such attacks. Other embodiments may test the high availability of an application running in a cloud, by using a variety of fault conditions. The fault conditions may emulate various types of real world faults. The cloud's response to the faults, as well as fault conditions, may be monitored.

A cloud performance index and ranking may be generated from multiple infrastructure testing KPls, and calculated against a baseline or benchmark used for comparison. The performance data may be used, and metrics can be monitored and correlated with the traffic patterns in the communications network, to predict potential cloud capacity problems before they occur. Multiple test results from the same cloud, or different clouds, may be visually represented at a user interface. This may allow for overlay of results and assessment of differences between current results and the baseline.

In certain embodiments, a database of the tested clouds and information about the cloud, such as hardware, software, hypervisor, and configurations thereof, may be managed. The information and test results may be aggregated, synchronized, archived, clustered, or grouped. This can allow for the logical centralization of the results, even if the tests are done regionally or on-site rather than being run from one place. The management of the test results may also allow for a comparison of currently tested data with prior tests, including a comparison with a reference cloud. Other embodiments, on the other hand, allow for the analysis of results of multiple clouds and displaying the variability of clouds and configurations.

Some embodiments may employ a one-click approach. In a one-click approach, a single initiating action by a user, such the pressing or clicking of a button, may initiate tests. The tests may be previously defined or scheduled via a test menu, thereby allowing the tests to proceed automatically with the pressing or clicking of a single button.

The testing of the application and the cloud infrastructure may also involve assessing the scaling up and/or scaling down of traffic in the cloud. For example, the cloud may have the ability to generate additional virtual machines in response to rapid demand changes in the cloud infrastructure. Such an assessment may be useful to ensure that the infrastructure and application can keep up with the scaling up of traffic, and to indicate any specific limitations or failure points where the infrastructure cannot cope with the traffic changes.

Certain embodiment may employ a fingerprinting application or virtualized network function from one or multiple vendors. Fingerprinting may allow a user to analyze the KPIs and to correlate the application with actual performance. In some embodiments, machine learning may be used to predict performance KPIs. For example, what-if changes in the configuration and hardware/software model behaviors of the applications may be done before implementing the application in the cloud.

Performance verification may be performed, in certain embodiments, in a fraction of the time needed, while being able to maintain a high confidence level. This verification approach may include the ability to generate fingerprints and/or patterns of the application that can be compared and matched with the typical fingerprints and/or patterns that run well in a given cloud.

In certain embodiments, the finger printing approach may include using a machine that learns to generate a virtual network function model. The machine may then measure the infrastructure performance of the target cloud, and apply performance data and/or an intended traffic model to the virtual network function model to determine a confidence level. A feedback loop of performance data may then be deployed, which may send data back to the virtual network function model.

In one particular embodiment, the virtual network function to be verified may be a call session control function (CSCF) subsystem of an IP multimedia system (IMS). An IMS CSCF model may be generated from previously collected performance data, for example, existing deployments in the customer cloud or lab testing. This performance data may then be processed through a machine learning framework that is capable of generating an IMS model, which may then generate the fingerprint. The type of performance data may include, for example, IMS performance KPIs or infrastructure performance KPIs.

The target cloud infrastructure performance data may then be collected and measured. The infrastructure performance data, along with the expected traffic model, may then be provided to the IMS model to determine the confidence level or probability of the IMS running as intended in the target cloud. Once the IMS can be used in production, the performance data may be utilized as a feedback loop to the machine learning framework to improve the model.

In certain embodiments, residual virtual machines and assets may be left in the cloud. These left virtual machines and assets can self-activate, in certain embodiments, and automatically perform tests as well as report results without any external intervention. The virtual machines and assets may then report and send an alert if sufficient changes are detected to trigger a more in-depth test regime. A supervising operator may then decide when and in what manner to perform the in-depth testing.

Some embodiments may allow for the functional decomposition of applications, which involves inserting decomposed modules into the cloud. The performance of the decomposed modules can then be tested at the module level, as well as in a full application level. A condition involving a noisy neighbor may also be assessed. The impact of the noisy neighbor on cloud performance in presence of other workloads in the same cloud may be evaluated.

The above embodiments may involve testing of a telecommunications application on a cloud infrastructure. The various results may allow for the network provider to determine how to allocate dynamic call, and how to handle traffic based on the cloud metrics.

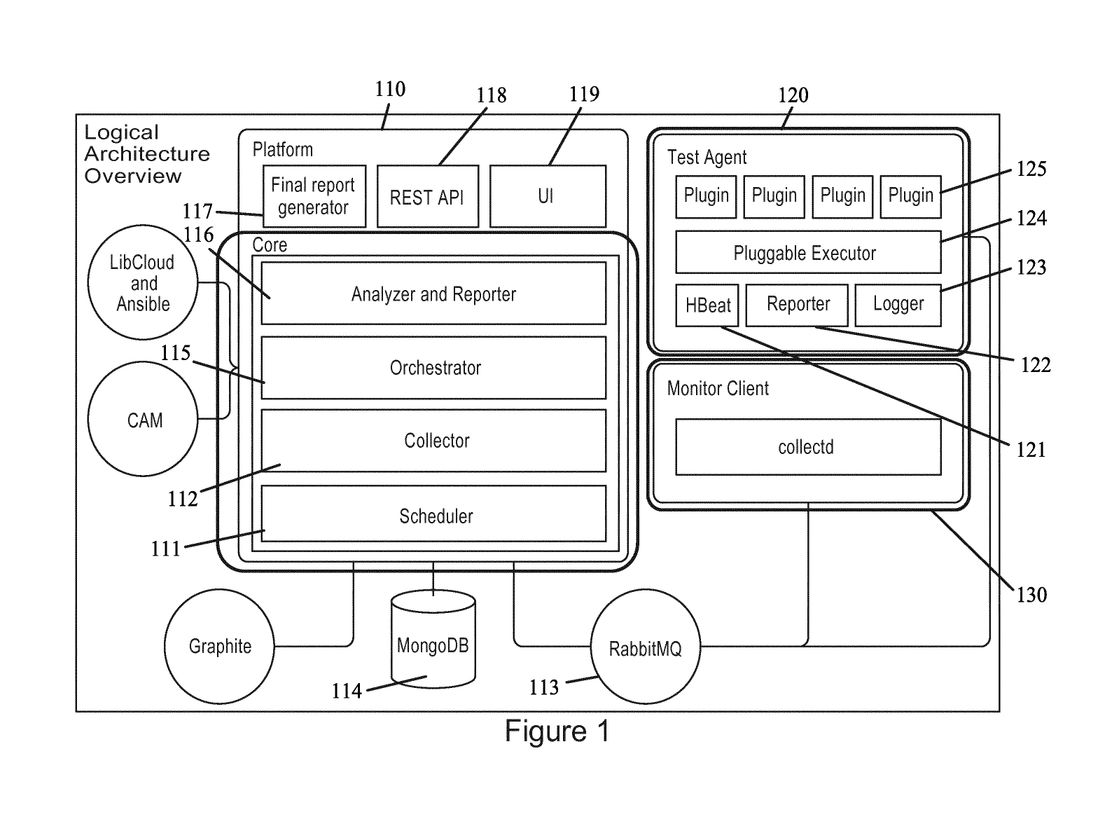

FIG. 1 illustrates a system architecture according to certain embodiments. The system architecture, for example, may include a platform 110. Each part of the platform 110 may be a device in itself, having a processor and a memory. The controller part of the platform can be deployed inside the cloud. In other embodiments, the platform can be deployed in a central location supporting multiple clouds being testing simultaneously. The platform 110 may also support multi-nodes deployment, which may still logically be seen as one cluster.

A scheduler 111 can be provided in the core part of the platform. The scheduler may be the main component that manages the lifecycle of a particular test. The lifecycle of a test may include several phases. For example, one phase may be the test planning phase in which a test instance will be created from a list of test templates, and assigned to a specific cloud. The test may then be configured and set to run on a scheduled time. A second phase, for example, may be a test execution phase in which a test instance may be executed. The progress of the test, and the resulting test metrics, may be monitored for at least part of the duration of the test, or the entire duration of the test.

Platform 110 may also include collector 112. Collector 112 may perform collection of important test related data. For example, test progress, test results, and test logs may be collected by collector 112. The collection of data may in some embodiments be done in real time via a messaging interface, such as a message broker software, for example, RabbitMQ 113. All of the collected data can be stored in a database of choice 114, such as MongoDB.

In certain embodiments, platform 110 includes orchestrator 115. Orchestrator 115 may be responsible for creating one or more test clusters in the cloud before the testing starts. Orchestrator 115 may create virtual machine instances, configure the networking between the instances, and install necessary software packages on those instances. Platform 110 may have its own internal orchestrator 115, which can be aided by external servers or software, such as Apache 2, LibCloud, and Ansible. In other embodiments, an external orchestration element, such as a CAM, may be provided with platform 110. In this external orchestration element all operations may go through a single orchestration interface which can be used throughout a variety of different implementations.

An analyzer and reporter 116 may also be included in platform 110. The analyzer and reporter 116 may analyze collected test data, generate cloud resources index and/or grades, and generate a final cloud report. In addition, this component may include a machine learning feature used, for example, to predict cloud capacity problems based on continuous low overhead testing of the cloud. In some embodiments, scheduler 111, collector 112, orchestrator 115, and analyzer and reporter 116 may be part of the core functioning of platform 110.

In certain embodiments, platform 110 may include a final report generator 117. A set of command-line tools may also be included, which can be installed on the same node as other representational state transfer (REST) components. The final report generator may provide the needed functionality to generate a report from the tested results, including graphs displayed on a user interface. The report may be compatible with any word processing software. REST application program interface (API) is also provided. REST API 118 can expose the cloud infrastructure and test metadata. REST API 118 may then report the tested metadata, and expose cloud operations, for example, test cloud connectivity, to external applications. The REST API, in some embodiments, may view user interface 119 as an external application.

User interface 119 (UI) can provide an interface for interacting with platform 110. UI 119 may be web based, in certain embodiments. UI 119 can allow users to plan tests of the cloud, monitor the progress of the test, and view and/or download the generated report.

The embodiment shown in FIG. 1 also includes a test agent 120. Test agent 120 helps to execute the tests scheduled by platform 110. Test agent 120 may be placed in one or more virtual machine instances of running test cases. Heartbeat (HBeat) 121 may be included in test agent 120. HBeat may be responsible for sending an IsAlive signal to platform 110. The signal may be interpreted by platform 110 as an indication that the agent is ready to perform the scheduled test.

Reporter 122 can also be included. Reporter 122 may send test progress updates and test results via the messaging interface to platform 110. The test progress updates and results may be sent to collector 112 in platform 110. Test agent 120 may also include logger 123, which handles logging operations of the test agent. Logger 123 may handle plugins during the execution phase of the test. The logs gathered by logger 123 may be sent to platform 110 via messaging interface 113.

In certain embodiments a pluggable executor is also provided. The pluggable executor 124 may execute all the test cases defined in a test instance that are sent by platform 110. Executor 124 can support additional new test case type, for example SPECCPU20xx test, via the plugin capabilities of test agent 120. In other words, a new test case may simply be developed as a new test plugin without the need to touch core part of test agent 120.

At least one plugin 125 may be included in test agent 120. Plugins 125 can be individual components responsible for individual test case execution. Such individual test case execution may include preparation before execution, test case execution, and/or collecting and reporting of test case results.

The embodiment shown in FIG. 1 also includes a monitoring client 130. Monitoring client 130 may be included in some or all instances involving test clusters. Monitoring client 130 collects resource usages for hardware of the cloud infrastructure, and may periodically collect KPIs for test monitoring purposes. The test agent and platform largely uses a collected library for system metrics collection and transfer.

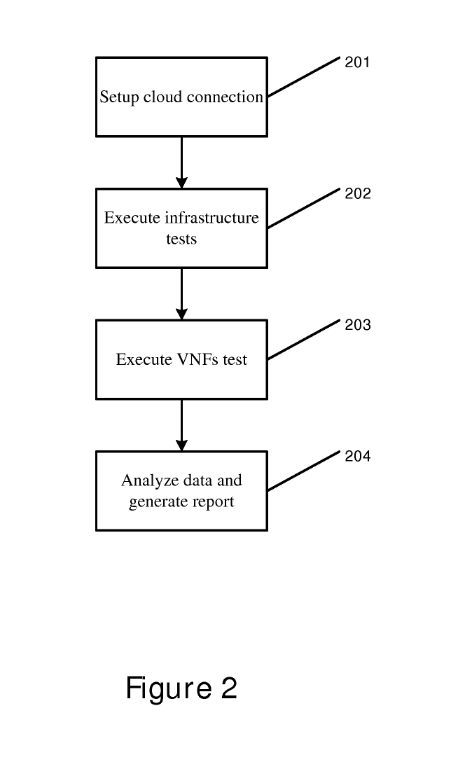

FIG. 2 illustrates a flow diagram according to certain embodiments. Step 201 may be the first step of a cloud verification service. Step 201 can include setting up cloud connectivity, which acts to ensure that the test platform has connectivity and access rights to the cloud management layer. If problems occur at this stage, an administrator may be notified.

In certain embodiments, step 202 includes executing infrastructure testing in order to test the performance of an application, such as a telecommunications application, on the cloud infrastructure. This testing may involve the use of virtual machines to simulate the running of the application on the cloud infrastructure. The cloud verification service may assess the performance of the computer, storage, and network services of the cloud infrastructure, as well as monitor the availability of the cloud service. In order to account for the variance in cloud performance, each test can be run multiple times. The final grade of the tests can at times only be generated when there have been at least three consecutive valid rungs, which helps to ensure that the generate data is statistically significant.

In some embodiments, the cloud verification service manages the full cycle of the testing such that it may create virtual machines, provision them, run tests on them, collect the results of the tests, and terminate all allocated resources.

Step 203 may be the virtualized network function (VNF) testing phase. In the VNF testing phase the cloud verification service runs tests that measure VNF-specific KPIs to assess the performance of installed applications. The results of the infrastructure and VNF tests are then presented, and compared to the reference point. The reference may be a previously tested cloud or a standardized cloud that has been predefined as a benchmark reference to VNF operation. The results of the tests may then be analyzed, and a report can be generated based on those results, as shown in step 204.

In FIG. 2, step 201 may include a setup cloud connection in order to access the testing service. The cloud verification service may be a multitenant service that can serve multiple users and test multiple clouds in parallel. To access the testing service, which can allow a user to test the cloud infrastructure, a user may use a username and password. Once a user has successfully logged on or accessed the service, the user may then choose whether to select a previously added cloud, or whether to select a new cloud.

In certain embodiments, when a user chooses to add a new cloud, including for example an openstack keystone service URL, a request for a user to have proper access credentials may be made. Access credentials may include a tenant name, a username, and/or a password. Once proper credentials are provided, the service can send the initial REST request to the cloud. Users may receive feedback about a failed or successful connection attempt. If the connection attempt is successful, a checkbox can be provided which can indicate that cloud REST API call was successful. If the connection attempt fails, then the reason for failure may be provided. A session token may then be provided in some embodiments.

Cloud verification service may run in hosted deployment models. This embodiment may include support for various cloud connectivity scenarios, while maintaining a centralized view of the management of the service. In some embodiments, only some nodes of the service can reach the target cloud. This may occur when a firewall is provided, which may only allow traffic from a certain IP pool, or even a single IP address.

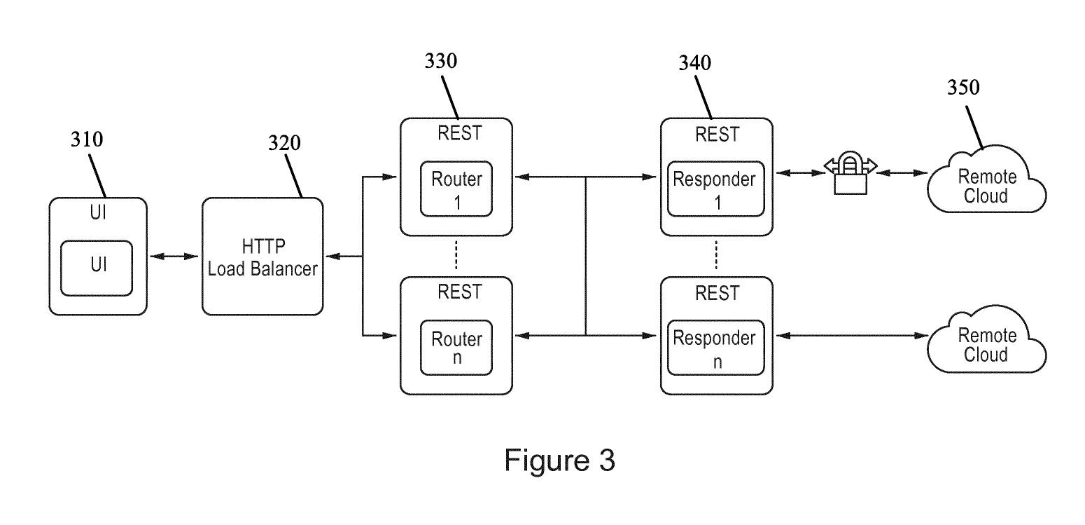

Another embodiment may involve connecting to the cloud through a virtual private network (VPN), which may also act to limit the nodes of service that can reach the target cloud. A VPN link to the cloud may be set up for one or more particular node. The VPN connection may not allow packet routing from outside of the VPN tunnel endpoint node. In order to handle connectivity to the cloud having restricted access, caused by a VPN or a firewall, the cloud verification service REST may include a router REST request, as shown in FIG. 3.

FIG. 3 illustrates a flow diagram according to certain embodiments. In particular, FIG. 3 illustrates the REST interface of the cloud verification service. The REST interface may be used by user interface 310, as well as other systems for integration. Certain embodiments may include making direct calls to cloud APIs, such as requesting a list of images or networks for a particular cloud. A REST router component may be responsible for routing such API calls to the at least one REST responder that can reach the cloud, making a direct request to the cloud, and subsequently sending the response back. A message broker may be used to facilitate communication between the REST responder and the router.

In the embodiment of FIG. 3, user interface 310 may send an hypertext transfer protocol (HTTP) request, through HTTP load balancer 320. The request may invoke the cloud API, and can arrive in at least one REST router 330. REST router 330 may then broadcast to all registered REST responder nodes 340 that cloud API has made a request. REST responder may then be used to connect to cloud 350, which at times may be locked via a VPN or a firewall. The response from the first REST responder node 340 can be sent back to the user interface. In some embodiments, the cloud identification may update the scheduler assignment configuration with the latest responder node information, so that the node can be the designated scheduler for handing the cloud testing.

In certain embodiments, there should be more than one router actively working. All responder nodes may be registered to the routers. The responder nodes may automatically register themselves. In some embodiments, a router node can also be a responder node, meaning that the functionality of both nodes may be combined into one physical node. Subsequent requests can be routed to known good responders, rather than broadcasting the request from the user interface to all responders. Responders may also be updated periodically and have a connectivity checkup. In addition, a responder may have a support list of hosts that may be known as a whitelist. The whitelist may include at least one defined cloud that the responder can exclusively serve.

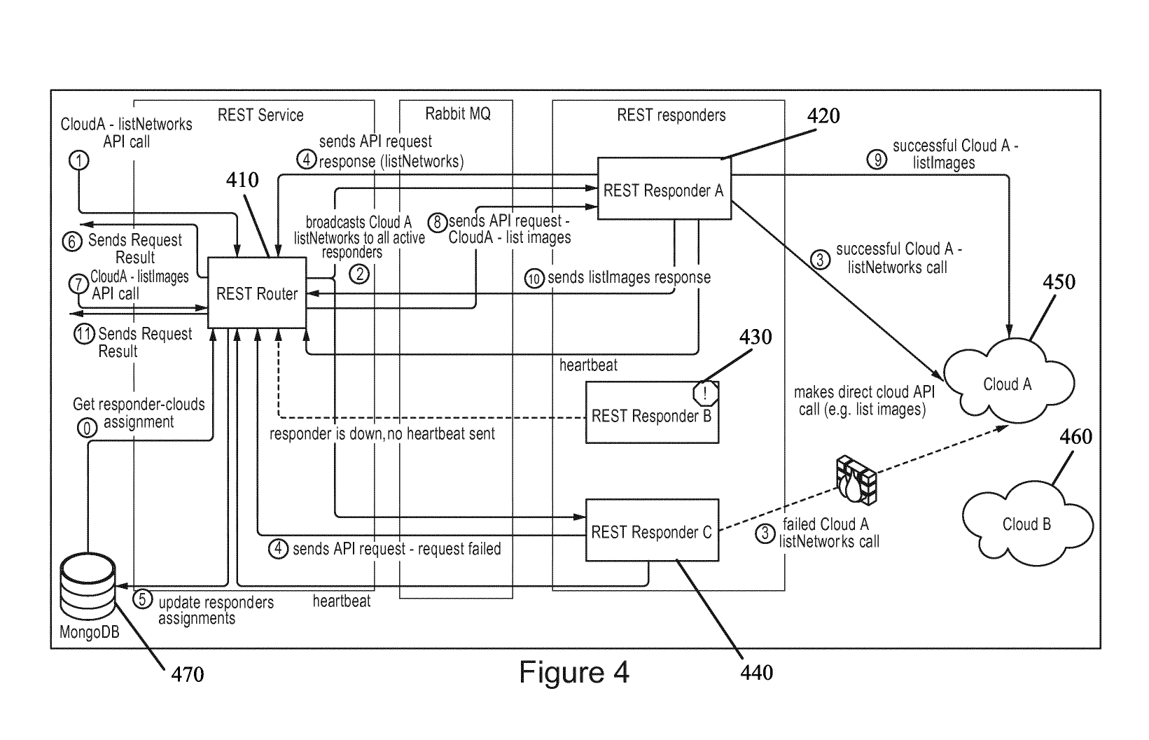

FIG. 4 illustrates a system architecture according to certain embodiments. FIG. 4 also illustrates a detailed view of a cloud REST API according to certain embodiments. In the embodiment of FIG. 4, there is one REST router 410 and three REST Responders (REST Responder A 420, REST Responder B 430, and Rest Responder C 440). Router 410 can route two cloud API REST requests to cloud A 450. The first API call may involve obtaining a list of networks, while the second API call may involve obtaining a list of images. Note that operations related to handling first call involve steps 1, 2, 3, 4, 5, and 6, while operations related to the second call involve steps 7, 8, 9, 10, and 11. Each step of the flow is numbered and described below the picture.

In step 0, REST router 410 may start by connecting to a database 470, for example MongoDB. REST router 410 may then acquire from database 470 mapping of REST responders 420, 430, and 440 to cloud A 450 and cloud B 460. REST responder A 420 may be assigned to handle requests to cloud B 460, REST responder B 430 may be assigned to cloud A 450 and cloud B 460, and REST responder C 440 may be assigned to cloud A 450. Once the routing is started, REST router 410 can start receiving heartbeat messages from responders. REST responders 420, 430, and 440 may be broadcasting heartbeats over a message queue.

In step 1, verification service REST API can be called with a request to list networks in cloud A 450. REST router 410 may be sent the request. REST router 410 can check which of the responders assigned to cloud A are alive, in step 2, using the heartbeat messages sent from the responders. Because REST responder B 430 may not be active, the list network request may be sent to all active responders sending heartbeats to REST router 410.

In step 3, responder A 420 and responder C 440 can make requests to cloud A 450. In certain embodiments, responder A 420 can make a successful call while the request made from responder C 440 fails as the cloud is not reachable due to a firewall restriction. In step 4, responder A 420 and responder B 430 may send back their results. REST router 410 then adds cloud A 450 to responder A 420 cloud assignments stored in database 470, in step 5. A successful response from responder A 420 can then be returned by router 410. This response indicated that a successful connection was established to cloud A 450, meaning that cloud A 450 has been successfully added.

A second call to cloud A 450 may then be initiated in order to request a list of images, in step 7. Since responder A 420 is already assigned to cloud A 450, the request is forwarded to cloud A 450 in step 8. If there is more than one responder assigned to cloud A 450, the request may be sent to the other assigned responders as well. In step 9, a call is made by responder A 420, and in step 10 responder A 420 may send back the request to REST router 410. In step 11, a successful response from responder A 420 is returned by REST router 410. The above embodiments may act to monitor exposed REST endpoints by retrieving a list of assigned responders, as well as a list of pending requests.

Once credentials to the cloud are provided, and a connection to the cloud is established, as shown in FIG. 4, users can provide additional parameters of the cloud configuration. These parameters may be used to determine the configuration of the cloud to be tested. Parameters may be split into several categories including instance configuration, flavor mapping, and a connectivity configuration. In order to simplify the configuration process, in certain embodiments, the cloud verification service exposes the REST interface to get data about at least one of available images, networks, zones, key pairs, or flavors.

In certain embodiments, instance configuration may include providing a default value related to launching test a virtual machine. The list of instance configuration parameters may include availability zones or virtual datacenter, which may be a default location where the test virtual machines can be launched. The instance configuration parameters may also include an image name, and a virtual application name, which can be the name of the image to be used for the testing of the virtual machines launched in the cloud. In some embodiments, the cloud verification service can also upload images to the target cloud if the images are not already present in the cloud. This can help simplify the cloud testing process. Another instance configuration parameter may be a floating IP protocol or an external network. According to this parameter, the virtual machine will receive a routable IP address from the network.

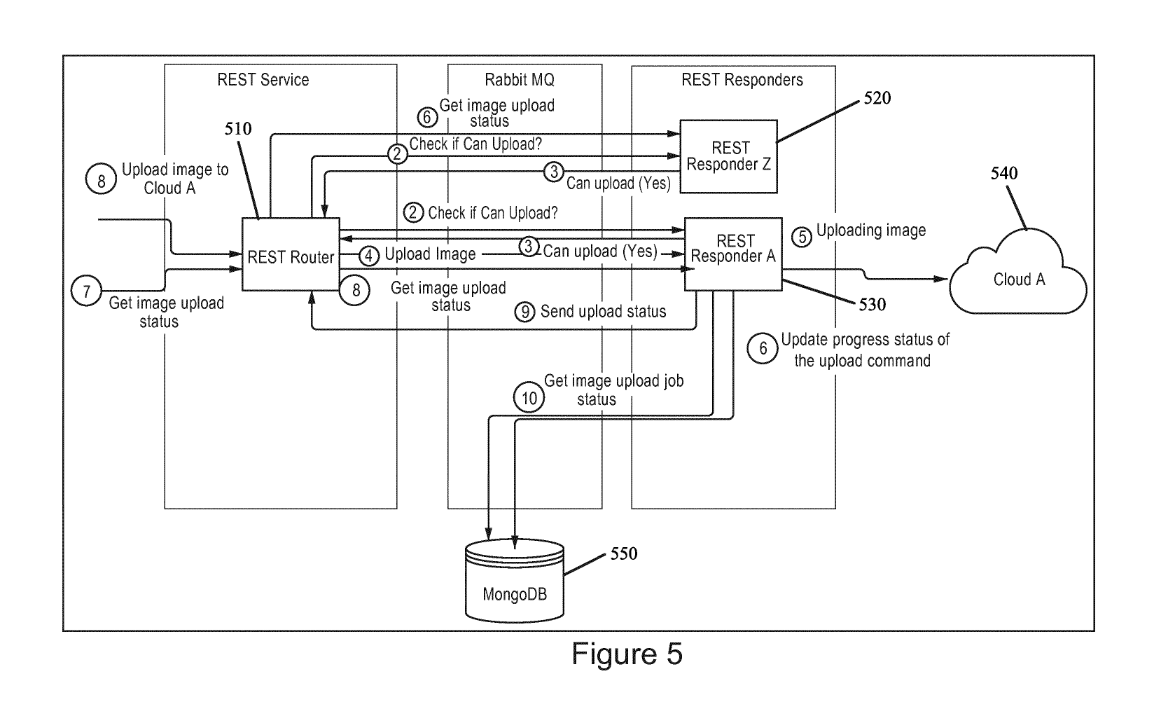

FIG. 5 illustrates a flow diagram according to certain embodiments. The flow diagram may represent an image upload flow to a cloud. In step 1, a REST API request to upload image to cloud A 540 arrives to REST router 510. REST router 510 may then send a query, in step 2, to a responder assigned to cloud A 540 in order to check if an image can be uploaded. In step 3, REST responder Z 520 and REST responder A 530 can check if they can be used to upload the image, meaning that the responders can check if the image file exists on the disk that may be accessed. In the embodiment of FIG. 5, REST router 510 selects REST responder A 530, in step 5, to handle the upload. In other embodiments, REST responder Z 520 may be chosen.

REST responder A 530 can check the status of the upload from the database 550. If there is an existing entry and the last update is fresh, for example within the last one minute, the database may ignore the upload request and return a message stating that the HTTP upload is already in progress. Alternatively, if there is no entry or the entry is old, REST responder A 530 may start the upload procedure to cloud 540, as shown in step 5. In step 6, REST responder A 530 can start the upload procedure. It may then update the upload task entry in the database on a consistent basis, including the last updated field.

A query about image upload status may then arrive at the REST router in step 7. The request is broadcasted, in step 8, by the REST router asking for an image upload status. The image upload status request may be sent to all responders, including REST responder Z 520 and REST responder A 530. In step 9, responders may check the upload status, and send the upload status to REST router 510. In some embodiments, only responders who are uploading images may respond to the get image upload status request. Step 10 illustrates a REST responder A fetching an image upload job status from database 550. If the worker identification has the same value as the environment identification, then database 550 may respond with an upload job status. If the worker identification is not the same value as the environment identification, then database 550 may respond with a message that indicates a bad request.

In certain embodiment, a cloud flavor may include a label that may be put on specific combination of virtual CPUs, memory, and storage. Both public and private clouds may use cloud flavors. However, there may not be any fixed standard on what a particular flavor means. For example, in one cloud flavor ‘m1.tiny’ can mean virtual machine with one virtual CPU, while in another cloud such flavor may not even be defined. In order to be able to keep test definitions from being tied down to a specific cloud environment, universal indexes may be used as flavors of the virtual machines. Each cloud may therefore have its own mapping of internal flavors to the universal indexes used in the tests. A flavor mapping configuration step can allow a user to establish this configuration.

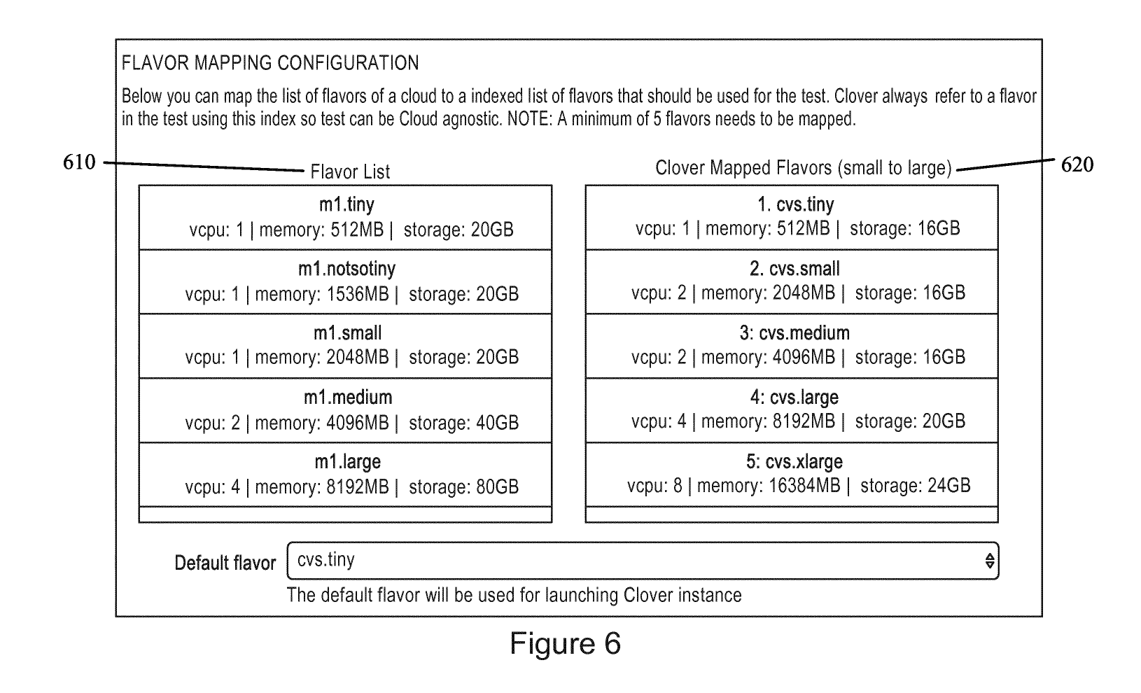

FIG. 6 illustrates a user interface according to certain embodiments. Specifically, FIG. 6 illustrates a user interface that can allow a user to choose a flavor mapping configuration. A user may map the list of flavors 610 of a cloud to an indexed list of flavors 620 that can be used for the test. The test can refer to a flavor using the index shown in FIG. 6 so that the test may be cloud agnostic, and not tied down to a certain cloud with a specific flavor. A default flavor may also be defined that may be used for launching a test instance.

In certain embodiments, an additional step of the cloud configuration may be to specify a domain name server and proxy settings. Those configurations can then be injected to test the virtual machines as part of the test provisioning steps.

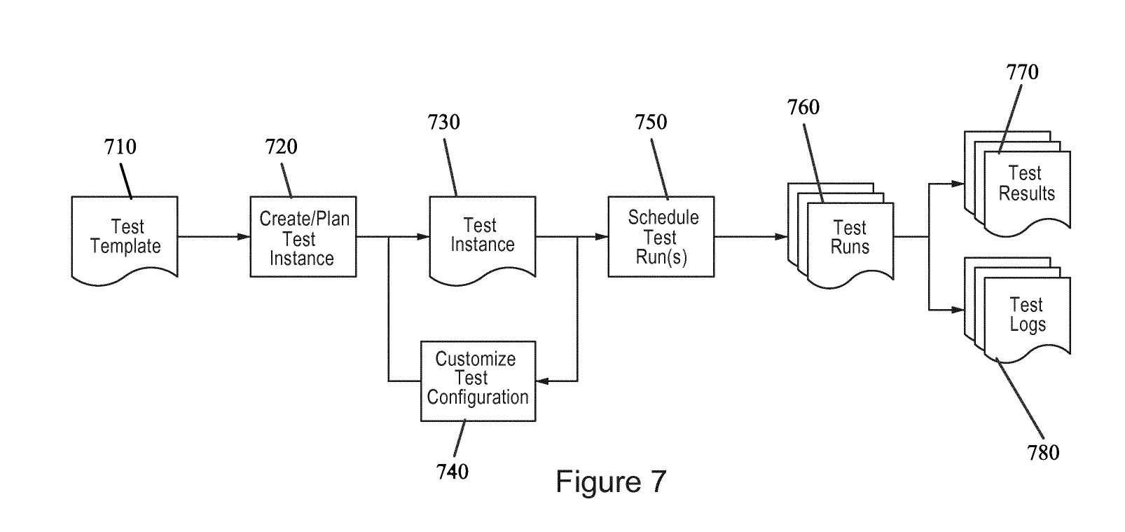

In some embodiments, each cloud may have a number of tests assigned to it during the planning phase. The testing, for example, may include cloud API performance testing, computing infrastructure testing, network infrastructure scaling testing, and/or network infrastructure testing. FIG. 7 illustrates a flow diagram according to certain embodiments. In the embodiment of FIG. 7 there can be test templates 710 stored in a database, which may be selected by the users. The test templates may describe which test cases should be run, when a test should be executed, and/or the topology of the target environment to be tested, for example, the configuration of the virtual machine or a back end storage.

A copy of the test template may be created and associated with the cloud, as shown in step 720. This copy of the test template may be known as a test instance document 730. The test instance, in certain embodiments, may be customized in step 730, before scheduling it into scheduler 111 of platform 110, as shown in FIG. 1. Customizing the test instance document may include changing some configurations of different test cases, and/or disabling or removing some of the test cases.

In certain embodiment, for each of the scheduled test executions 750, a test run document can be created. Test run 760 can be a copy of the test instance document from which the original execution was scheduled. The test run 760, therefore, can also contain snapshots of important test configuration and environment information, at the time of execution that may be used for historical purposes whenever there may be a need to audit a previous test run. Each test run execution may generate multiple test result documents 770 and test log documents 780 that are associated with the test run document for the execution of a single test.

In some embodiments, the test may be launched through a Cron expression. Each test instance, for example, can have one Cron expression specified for one or more future execution times. The Cron scheduling can also support a validity period, when such a period is specified. The test may not be executed when the scheduled run is outside the given validity period. The user may specify the validity period in the user interface. The user may specify the date, time, and length of the validity period. A user may also specify in certain embodiments that a test case may be run in parallel, or that all test cases should be executed, regardless of failure.

In certain embodiments, a test may be launched through an ad-hoc one time execution. The test may be executed briefly after the scheduler receives the test instance schedule. In addition, some embodiment may employ a “one-click” approach. In a “one-click” approach, a single initiating action by a user, such as pressing or clicking of a button, may initiate the tests. The tests may be previously defined or scheduled via a test menu, thereby allowing the tests to proceed automatically with the pressing or clicking of a single button, as discussed above.

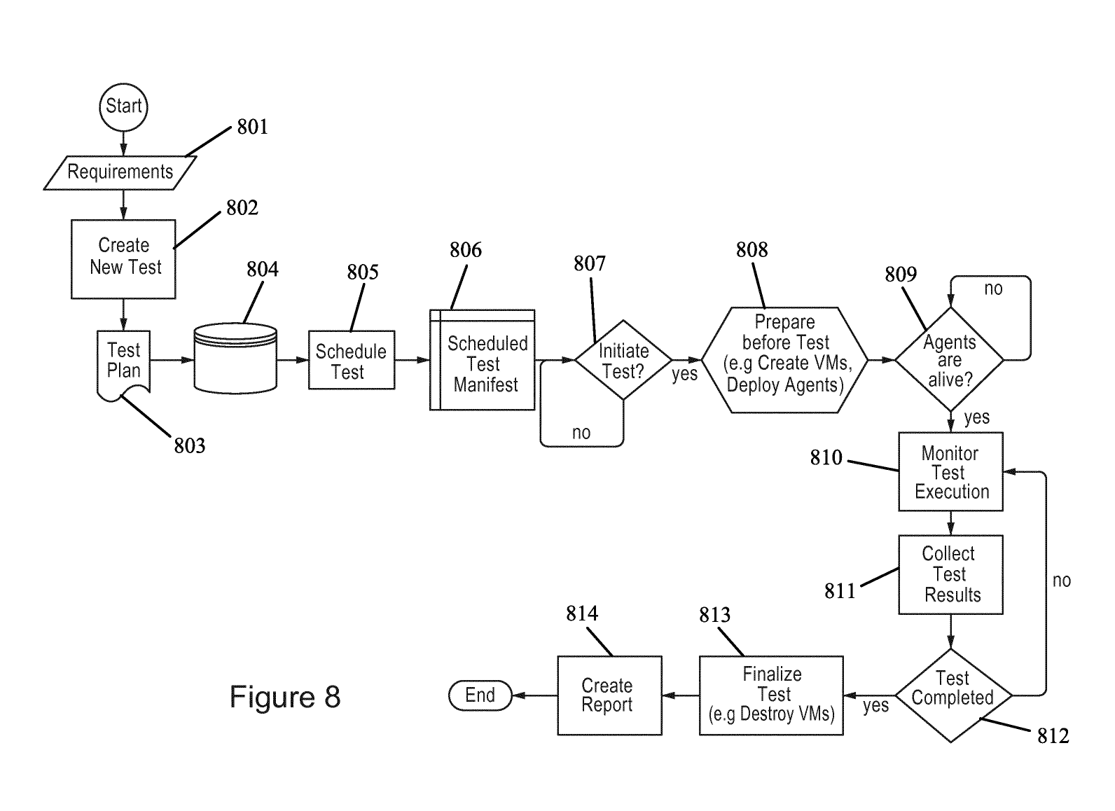

FIG. 8 illustrates a flow diagram according to certain embodiments. The embodiment of FIG. 8 represents a test execution flow from the platform perspective. In step 801, a user may log into the testing service by inputting certain requirements, such as a username and a password. In step 802, a user interface may be used to determine a new cloud to test. The user may be required, in some embodiments, to enter the credentials of the cloud including an authorizing URL, a tenant, a username, and/or a password. The tested cloud may then be accessed through a remote location using the inputted credentials.

In certain embodiments, the test may be planned, as shown in step 803. Planning of the test can include using test templates that allow for testing of various aspects of the cloud. Tests may be planned for cloud services running in the cloud, computing, network, storage, and applications, such as virtualized telecommunication network functions, for example, an IMS. The templates may then be put into the configuration for testing. In step 804, a user may select a database of choice to store the collected data. In some embodiments, the user may also draw references or benchmarks from the database to use when comparing the current testing.

In step 805 a user may schedule the test. A schedule test manifest can then be shown through the user interface, in step 806. After reviewing the manifest, a user can choose whether to initiate the test. If the user chooses to change the test configuration shown in the manifest, the user may go back and reconfigure steps 802, 803, 804, and 805. Otherwise, the user may initiate the test in step 807. In some embodiments, the cloud can be tested using full automation. Once the test has been initiated, several setup steps can be prepared before the actual testing is done, as shown in 808. For example, virtual machines can be created, and the test agent, illustrated in FIG. 1, can be deployed.

In step 809 a determination can be made whether the agents are alive. This determination can be based on whether heartbeats 121, as illustrated in FIG. 1, are sent from the agent to the testing platform. In certain embodiments, one agent may not be alive, and the test collection and monitoring in that one agent may be stalled until an indication is received that the agents are alive. In other embodiments, the agents may indicate that they are active and the test can be monitored by the platform, as shown in monitor test execution step 810. In certain embodiments, users can review both progress of the testing as well as detailed logs, while the testing occurs before a final report may be created. The test results may then be collected in step 811.

In step 812, a determination may be made of whether the testing is completed. If not, the testing, as well as the monitoring and collection of data in steps 810 and 811, can continue. When the testing is completed, then the testing may be finalized, and the virtual machines may be destroyed, as shown in step 813. A report can then be created by the platform, as shown in step 814, which can allow users to easily review the results of the tests. The report may be presented within the user interface of the service.

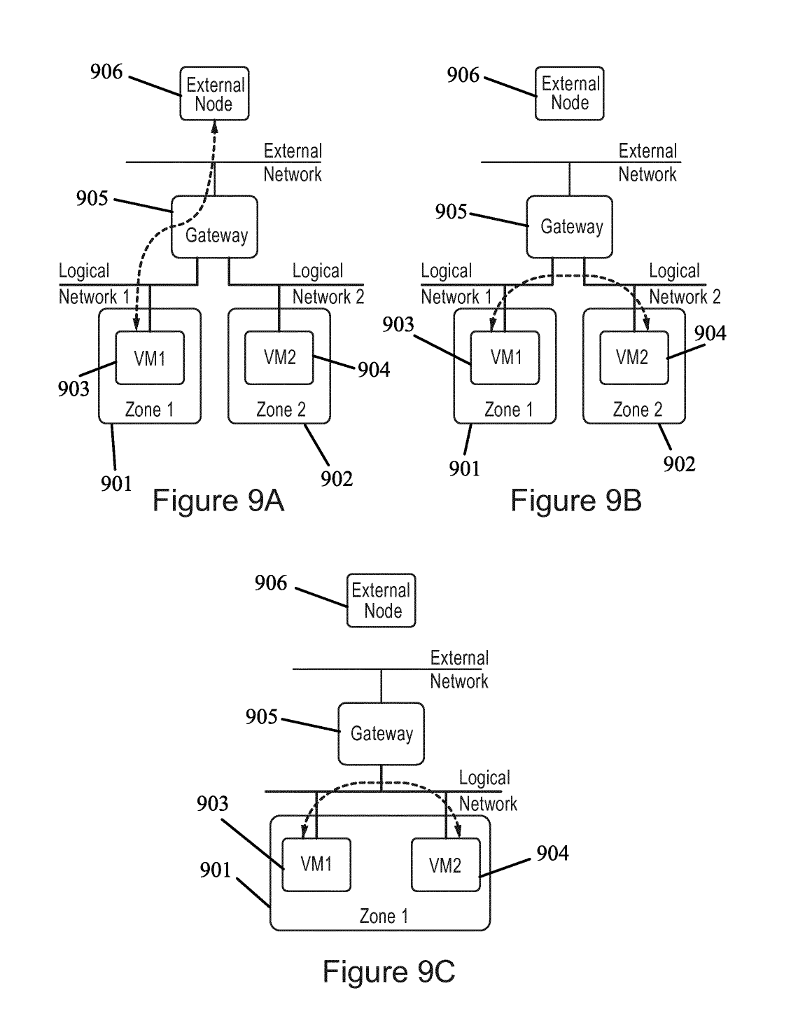

Networking testing, as explained in step 803 in FIG. 8, can be done on different network topologies, for example, an inter-availability zone topology, an intra-availability zone topology, or an external gateway topology. FIG. 9A shows a topology according to certain embodiments. In the embodiments of FIG. 9A, performance may be tested between a node inside the current cloud and a node outside the cloud environment. Specifically, the performance between virtual machine 1 903, located in zone 1 901 of the cloud, and an external node 906 may be tested. Gateway 905 may be used to facilitate the interaction between virtual machine 903 and external node 906.

In other embodiments, as shown in FIG. 9B, the performance may be tested between two nodes in different available zones, which leads to an inter-availability zone topology. Virtual machine 1 903, located in zone 1 901, can interact with virtual machine 2 904, located in zone 2 902. In yet another embodiment, shown in FIG. 9C, performance may be tested for an interaction between two virtual nodes 903, 904 in the same availability zone 901. The testing may be run repeatedly using the network topologies exhibited in FIGS. 9A, 9B, and 9C.

In certain embodiments, traffic can be run through these different topologies. The traffic may have different packet sizes, and use different network protocols, for example, TCP, UDP, and SCTP. This can allow for the evaluation of latency and bandwidth from the network perspective.

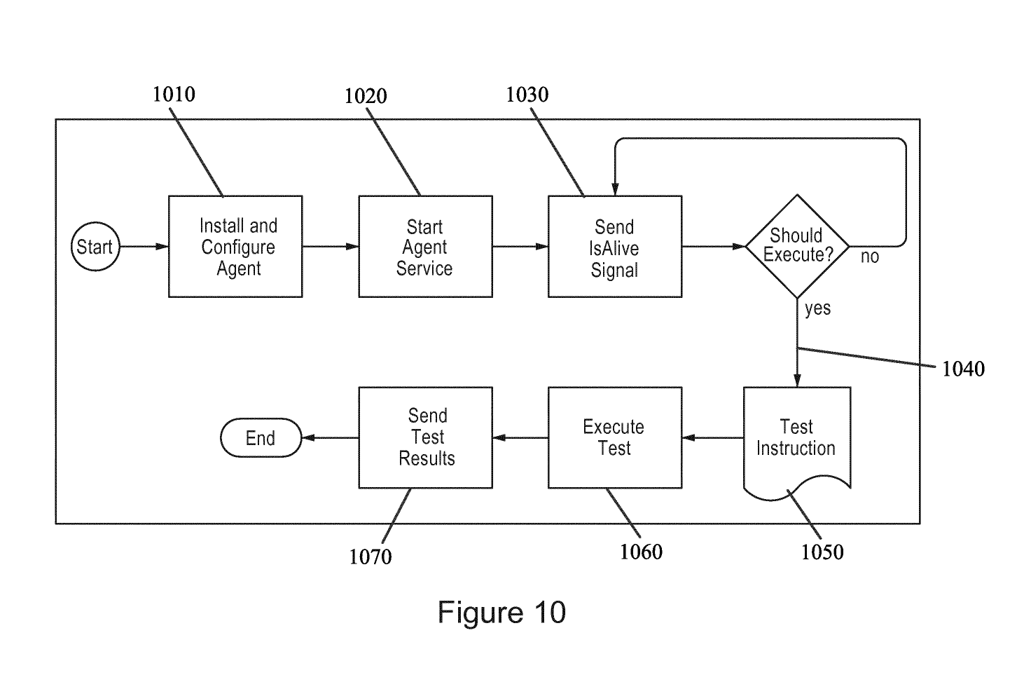

FIG. 10 illustrates a flow diagram according to certain embodiments. In particular, the flow diagram is shown from the perspective of the test agent. In step 1010, an agent is installed and configured. The agent may be be used to aid the platform in the testing of the cloud infrastructure during the running of an application. The agent service can be started or deployed as shown in step 1020. The agent may send an “IsAlive” signals to the platform, in step 1030, to indicate to the platform that it can execute the testing. In step 1040 the agent may wait for an instruction from the scheduler to begin to execute the testing. If the user does not give the agent permission to proceed, then testing may not be executed, in some embodiments. The agent may then continue to send “IsAlive” or heartbeat messages to the platform to indicate that it can begin the testing. In other embodiments, the scheduler may send a request to execute the program, which may allow an agent to execute the testing. The agent may receive test instructions from the platform in step 1050, and begin executing the test in step 1060. The test results can then be sent to the platform in step 1070.

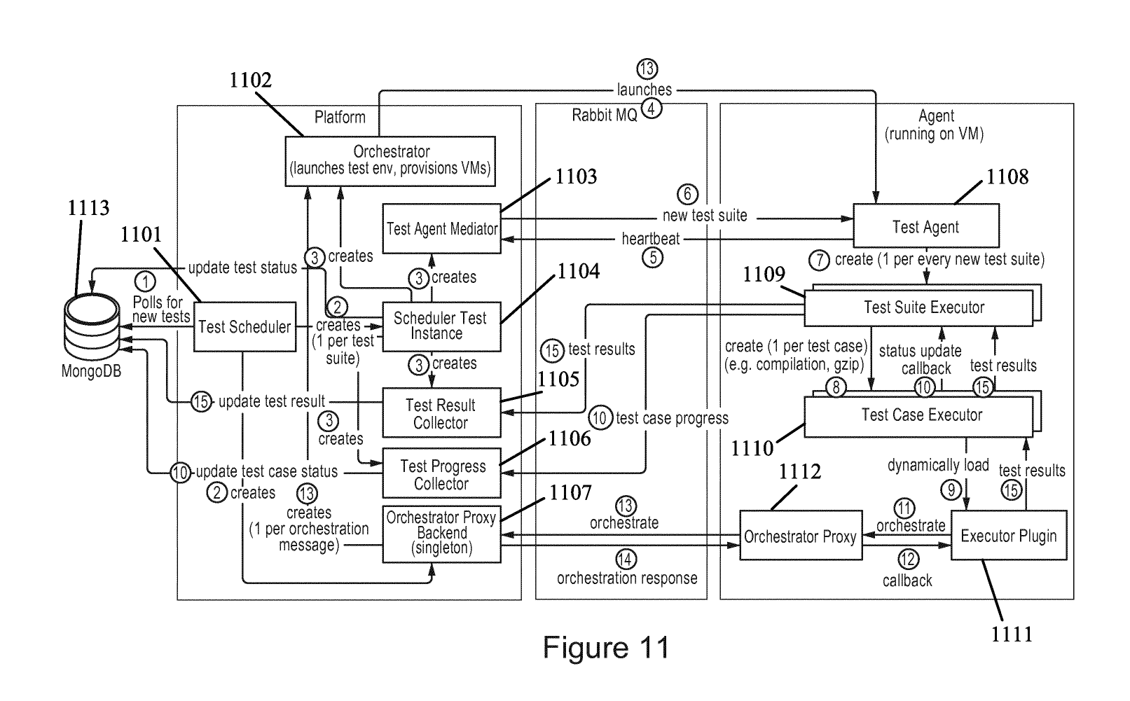

FIG. 11 illustrates a system architecture according to a certain embodiments. Specifically, FIG. 11 illustrates the interaction between the platform 110 and the test agent 120, shown in FIG. 1, during test execution. The scheduler may periodically poll for new tests that may be started during that time. In step 1, when scheduler 1101 finds a test to be started, it creates a scheduler test instance 1104 that can manage the test life cycle, as shown in step 2.

Within scheduler test instance 1104, multiple instances of different types may be created in step 3 that can process different tests. For example, the instance types can includes test agent mediator 1103, which can handle main interaction with the test agent 1108. Orchestrator 1102 can also be created, which may be responsible for cloud provisioning and test tooling configuration. In addition, test result collector 1105, which may collect test results from the testing, and test progress collector 1106, which may collect live test progress updates.

In step 4, once scheduler test instance 1104 has been initialized, it may first instruct orchestrator 1102 to launch one or more virtual machines. The virtual machine can include installation and configuration of testing software and a test agent 1108. In certain embodiment, test agent 1108 comes alive in step 5, and starts sending a heartbeat through the test agent mediator 1103, via a messaging interface or bus, for example a RabbitMQ. Test agent mediator 1103 can recognize the heartbeat, and send the test suite document to the agent 1108 via the messaging bus, in step 6. Based on the test suite document received by test agent 1108, test agent 1108 may create at least one test suite executor 1109 to start the test suite execution, in step 7.

In some embodiments, test suite executor 1109 can further delegate each test case to a test case executor 1110, as shown in step 8. Test case executor 1110 can determine the plugin that needs to be loaded based on the test case specification, and may dynamically load the executor plugin, in step 9. Test case executor 1110 can in some embodiments immediately send test case progress updates via a callback mechanism to test suite executor 1109, which may then send the update to test progress collector 1106 via messaging bus in step 10. Once the test progress updates are collected by test progress collector 1106, the update can be sent and stored in database 1113.

In certain embodiments, depending on the test case, executor plugin 1111 may perform further orchestration via the orchestrator proxy in step 1112, in step 11. In step 12, the orchestrator proxy 1112 may immediately respond to the orchestration request via a callback mechanism. Orchestrator proxy 1112, in some embodiments, may encapsulate the request via the messaging bus to orchestrator proxy backend 1107, which can create a new orchestration instance, in step 13. In step 14, the created orchestrator instance may start the orchestration process to the cloud as instructed.

After executor plugin 1111 finishes the execution of the test case, it may send the test results to the test case executor 1110, which can then forward the results to test suite executor 1109, in step 15. Test suite executor 1109 can then send the test results from the agent, through the messaging interface or bus, to the test results collector 1105 located in the platform. The results may then be stored in database 1113.

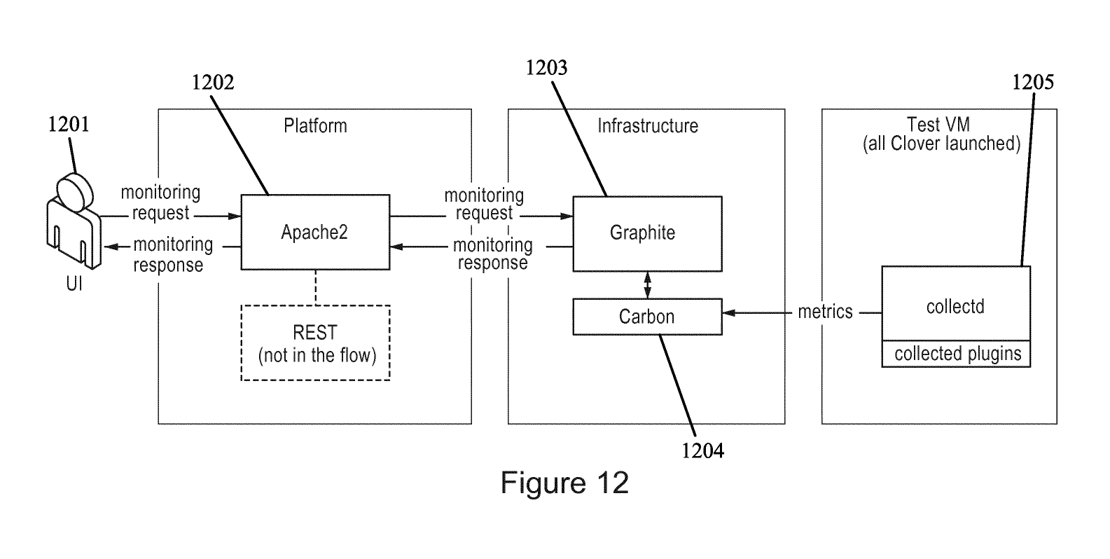

FIG. 12 illustrates a flow diagram according to certain embodiments. During execution of the test, a user may monitor utilization of cloud resources and basic KPls, such as CPU, usage, or memory usage. This allows for the user to quickly discover some basic problems with the test and/or cloud infrastructure, without having to analyze and debug the logs. In other words, the user may view and/or collect live metrics during the test.

FIG. 12 illustrates an embodiment in which a user can live monitor various test metrics. User interface 1201 may be used to send a monitoring request to “apache2” 1202, which may be an HTTP server which communicated with the orchestrator in the platform. “Apache2” may be included in the orchestrator in the platform. The monitoring request can be forwarded through graphite 1203 and carbon 1204 located in the cloud infrastructure. The collected data may then be sent from the collected plugins 1205 in the test virtual machine, through the cloud infrastructure back to “apache 2” 1202. The data may then be forwarded to the user interface 1201 for viewing by the user. In one embodiment, the CPU load and memory usage may be plotted as live metrics that can be used to monitor the execution of the test.

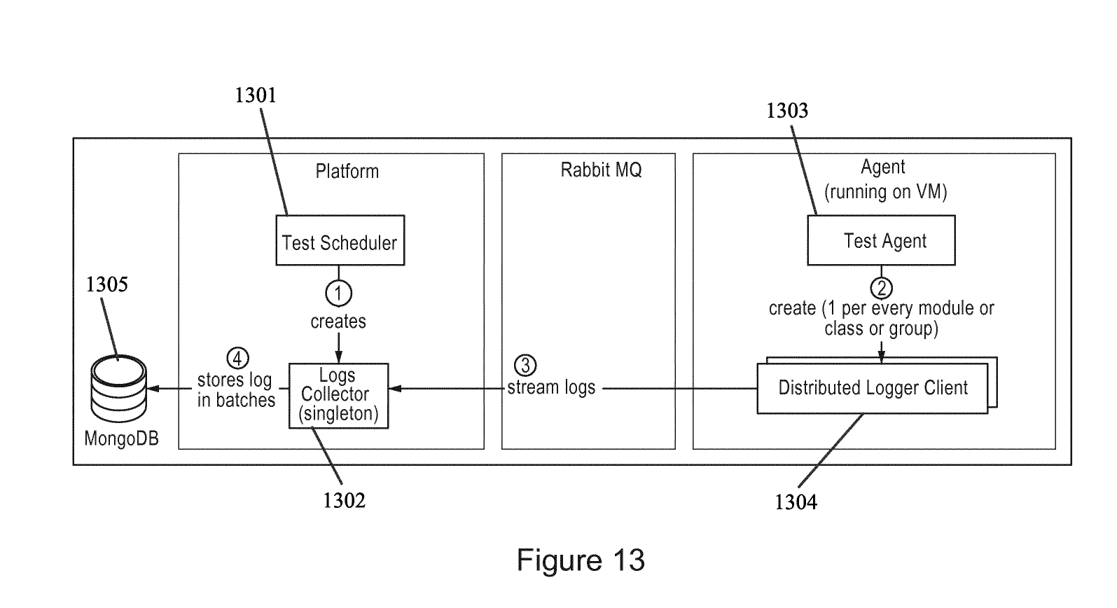

FIG. 13 illustrates a flow diagram according to certain embodiments. In order to ease monitoring of the test execution, the cloud verification service may implement distributed logging. Distributed logging may help avoid logging to each of the test virtual machines, and may provide all logs under a single view.

In certain embodiments, in step 1 test scheduler instance 1301 in the platform creates a logs collector 1302 during initiation of the testing, which can act as receiving end of streaming logs from multiple sources. In step 2, test agent 1303 in the agent creates one or more distributed logger client 1304 instances to stream logs to the platform. Distributed logger client 1304 may then start to stream logs to the platform via the measurement interface, in step 3. At the platform end, logs collector 1302 can receive the streamed logs, and store them in database 1305. In certain embodiments, the logs may be immediately stored upon receipt. The logs may also be stored in multiple batches.

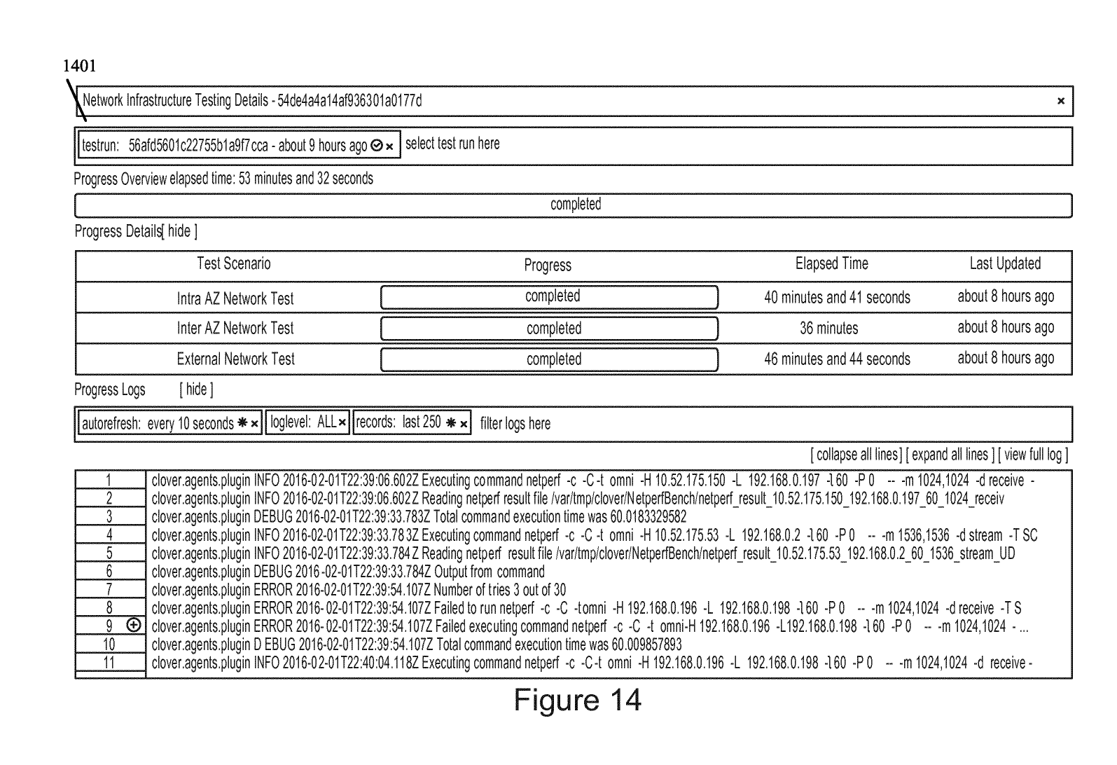

FIG. 14 illustrates a user interface 1401 according to certain embodiments. The user interface can include a progress overview, including the amount of time elapsed since testing began. The user interface 1401 may also illustrate progress details, including the amount of progress for each executed network test. In some embodiments, specified code showing the tested progress logs may be shown. Logs stored in the database may be exposed via the REST interface, which can allow presentation of the logs in the user interface.

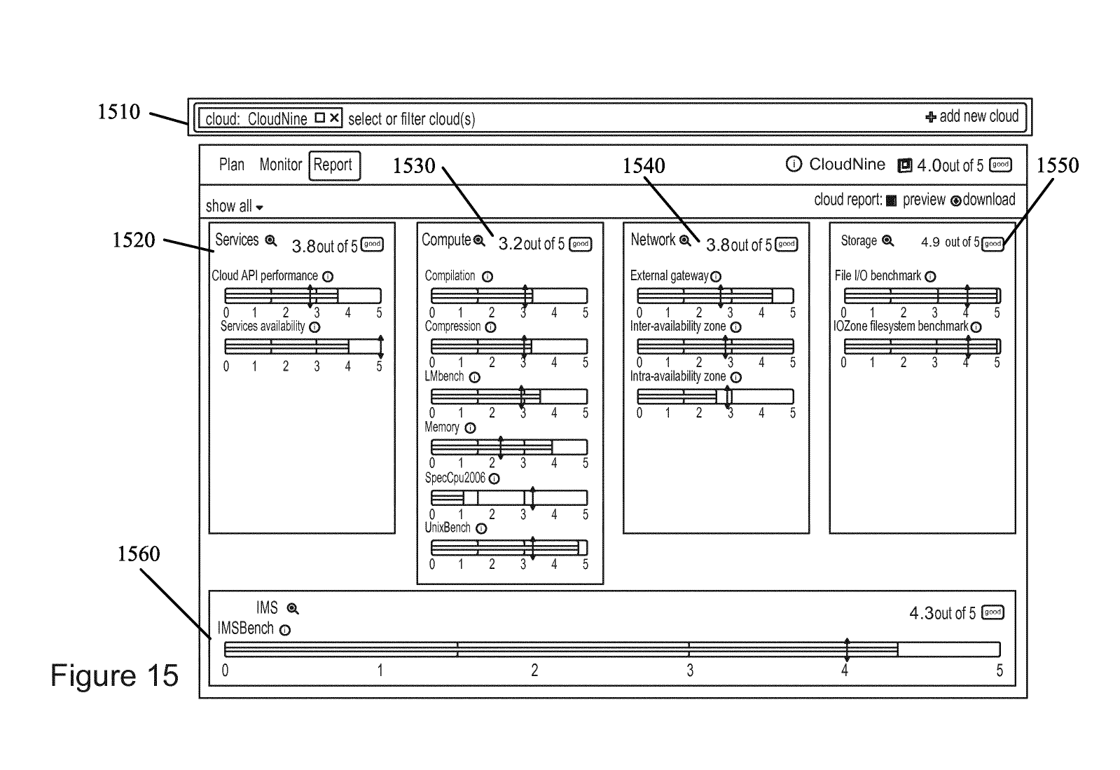

FIG. 15 illustrates a user interface according to certain embodiments. Specifically, user interface 1501 shown in FIG. 15 may illustrate a high level results view that can allow for comparison of results between clouds. As discussed above, the verification service includes a reference cloud which may be used as a benchmark when viewing the results. Each tested cloud may be graded based on the relative performance of the cloud to the reference cloud results. The initial output can be a cloud grade, which in the embodiment shown in FIG. 15 is a single number with a discrete score between zero to five. Scores may be provided for each of the infrastructure and applications tests.

This top level view can be broken down into specific results for each category of tests. For example, the overall performance of the cloud may be divided into at least one of services 1520, compute 1530, network 1540, storage 1550, or application 1560. The user may be provided with a score between zero to five describing the overall performance of the cloud infrastructure. Further, each of the above categories may be split up into further categories, which may also be graded on a scale from zero to five.

The compilation score of the current test may be shown by the horizontal lines within each category. For example, the service availability under services 1520 was tested as having an approximate grade of 4 out of 5. In addition, certain embodiments may include a vertical bar or an arrow that show the reference scores for the same test for a reference cloud. This may allow clouds to be compared with other clouds, or alternatively with previous results from the same cloud. For example, the services availability category under services 1520 has a reference cloud score of around 5. A user may select a specific reference cloud from the archives.

The cloud grade calculation may be computed using different methods. Some embodiments, for example, generate a test case grade per flavor, for example, a 7-Zip test. For each flavor, the average test measurements value of each KIP may be calculated. In addition, the KPI grade may be calculated by mapping previously calculated average values to the right of the threshold range. The calculated test case grade may also be calculated using a weighted grade average of all calculated KPI grades.

In other embodiments, the test group grade may be calculated per cloud resource, for example, a compression test. For each of the test groups in a cloud resource, the test case grade average may be calculated for all flavors in a test group by averaging the test case grades from all flavors. In addition, the test group grade may be calculated by performing a weighted average of the calculated test grade for all flavors.

In certain embodiments, a cloud resource grade may be generated. The cloud resource grade may be used in the compute 1530 category. The cloud resource grade may be calculated by averaging all test group grades. When a test group weight is predetermined, then the weighted average may be calculated. If not, then the weight may be divided evenly. In some embodiments, a cloud grade can be generated by averaging some or all of the cloud resource grades.

Viewing the results within each category may in some embodiments be presented in context of the reference cloud score. As shown in FIG. 15, the categories may be at least one of services 1520, compute 1530, network 1540, and storage 1550, or application 1560. As shown in FIG. 15, the vertical arrows shown in the user interface may represent the reference cloud score. Each tested metric may be illustrated in comparison to the reference cloud score.

In some embodiments, instead of the vertical line shown in FIG. 15, the cloud scores may be shown as a vertical histogram having percentages in the horizontal axis. The reference cloud score can be at the zero percentile mark of the histogram, with the bars shown in the histogram ranging from negative percentiles, left of the zero mark, to positive percentiles, right of the zero mark. A negative percentile may indicate that the current tested metric had a lower score than the reference cloud score. A positive percentile, on the other hand, may indicate that the current tested metric had a higher score than the reference cloud score. The higher the percentile, the better the performance of the current test.

In another embodiment, a horizontal performance histogram or bar chart may be used to report the metrics of the current test. This may allow for more specific evaluation of the metrics, including, for example the performance of different file sizes with latency for GZIP compression in different machine types. This can allow for a more detailed and parametric view of the metrics than the cloud grade calculation described above. In another example, in networking category 1540 throughput in an inter-availability zone topology may be measured in megabits per second, based on SCTP, TCP, or UDP protocols.

As shown in FIG. 15, a telecommunications network application may be tested. For example, an IMS may be tested. The user interface may be used to input a network subscriber load, traffic load, and/or a traffic patterns. A temporal view of the application performance may be viewed, in certain embodiments.

In other embodiments any type of tested metrics can be presented in any form, whether it be in a chart, such as a scatter chart, a table, a graph, a list, a script, or any other form that may be compatible with the user interface.

In certain embodiments, in order to simplify on-boarding of a new test tool, the cloud verification service can implement a widget concept on the user interface side. This widget concept may allow for the viewing of the results in a dashboard defined in javascript object notation (JSON) format. In certain embodiments, the dashboard specification can be retrieved and processed via JSON. The test result data can then be retrieved, and the widget generated.

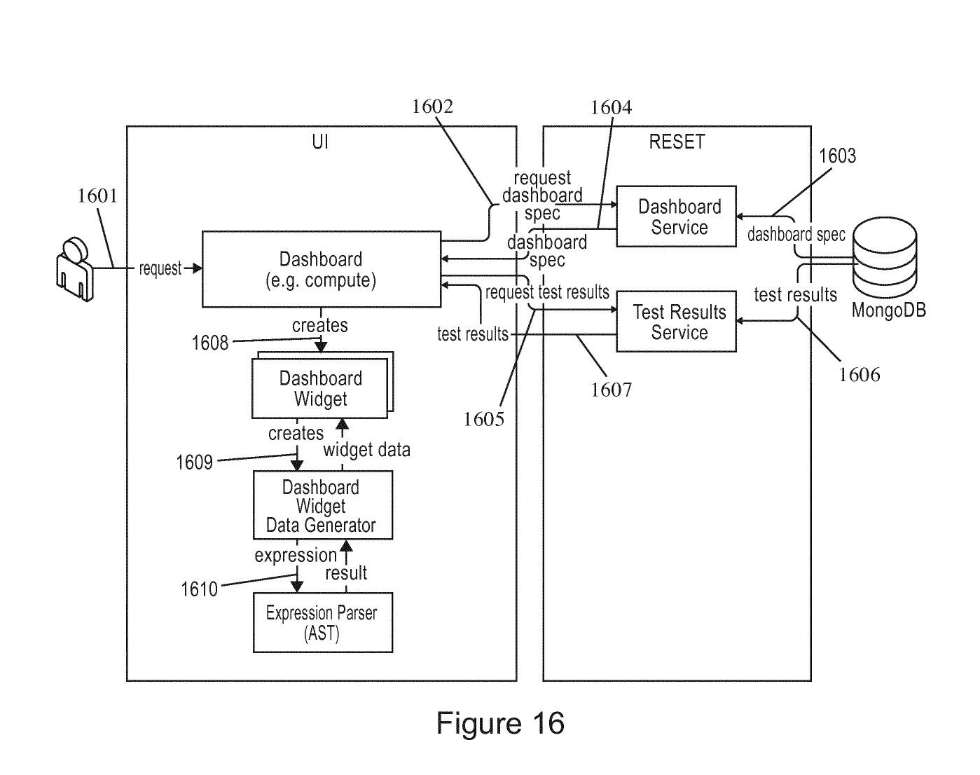

FIG. 16 illustrates a flow diagram according to certain embodiments. In step 1601, the user requests a dashboard. The user interface dashboard module then requests dashboard specification via REST API, as shown in step 1602. The dashboard specification may then be sent from a database, such as a MongoDC, to the REST API, in step 1603. Based on the dashboard specification returned to the user interface, in step 1604, the user interface dashboard module may request test data via REST API, in step 1605. The test results may then be sent from a database to the REST API, in step 1606, and the results can be forwarded to the user interface, as shown in step 1607.

In certain embodiments, the user interface dashboard module may then create one or more dashboard widgets, in step 1608, according to the dashboard specification. The dashboard widget may include the filtered test results data, as specified in the widget specification. In step 1609, the dashboard widget processes and transforms the filtered test results data via the dashboard data generator into a form that is expected for visualizing the widget. In certain embodiments, the dashboard data generator may utilize the abstract syntax tree (AST) expression parse utility to parse any expression that exists in the widget specification. The results can be forwarded to the dashboard widget data generator, which can then send the widget data to the dashboard widget.

A final report may be generated by the cloud verification service, and may include a final report document that summarizes test activity. In some embodiments, the final report generation process may include the retrieval of cloud data from a database, and using a predefined template descriptor, which may help to define how the documents are to be assembled, and/or which graphs are to be generated and included in the report. The report database plugins can then be processed, and the report variable can be created. Ultimately, any form of document may be generated. In some embodiments the generated document may be encrypted or encoded. The document may also be streamed via an HTTP protocol to the web browser of the user.

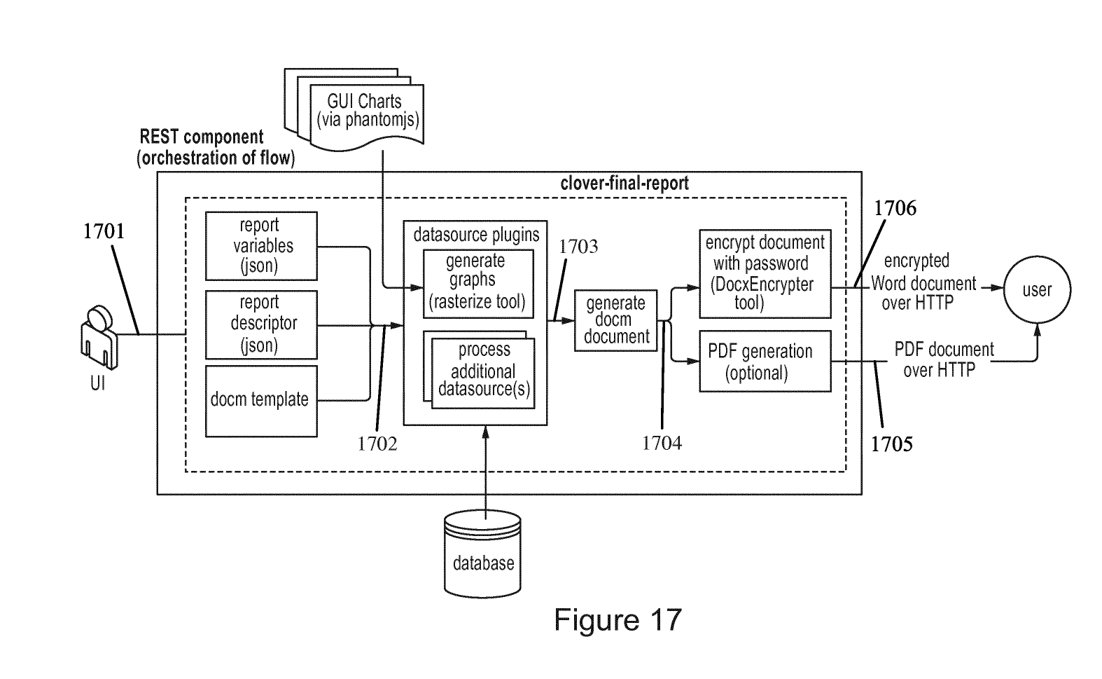

FIG. 17 illustrates a flow diagram according to certain embodiments. In step 1701 the user may request a final report. The document may be assembled according to at least one of a predefined template, JSON report variable, and/or JSON reporter descriptors. This document assembly information may then be forwarded to a datasource plugin, in step 1702. The datasource plugin may then collect data from a database and/or draw information from a graphic user interface. The plugin can then generate graphs and process additional datasources to be presented in the final report.

The datasource plugin may then generate a document in step 1703, and send the document to the user in step 1704. Before the document reaches the user, however, in certain embodiment the document may be encrypted with a password, using for example, a docxencryptor tool, in step 1704. In certain embodiments, therefore, the document may be encrypted over HTTP and sent to the browser of the user. In other embodiment, rather than encryption, the report can merely be sent as a document without encryption, for example, a PDF document, over HTTP.

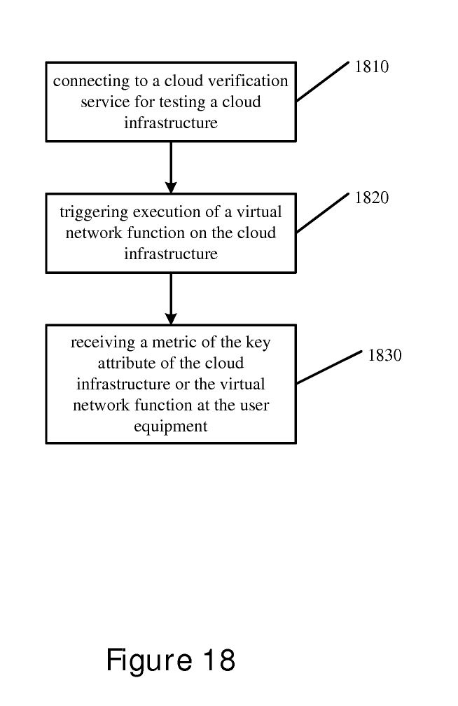

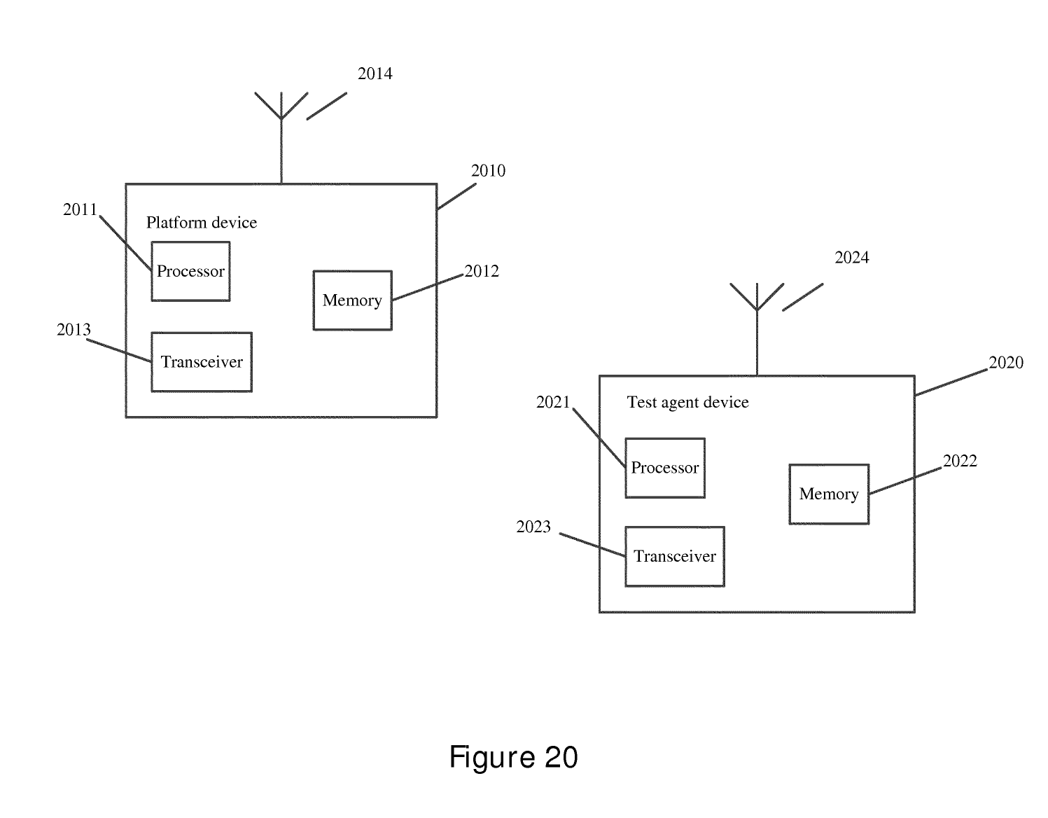

FIG. 18 illustrates a flow diagram according to certain embodiments. A user may first connect to a cloud verification service for testing a cloud infrastructure, as shown in step 1810. In step 1820, a user equipment may trigger execution of a virtual network function on the cloud infrastructure. A key attribute of the cloud infrastructure with the executed virtual network function may then be tested, using the cloud verification service. Key attributes may include categories of the cloud infrastructure such as services, computing, networking, or storage. A metric of the key attribute of the cloud infrastructure or the virtual network function can be received at a user equipment, as shown in step 1830. The metric can be displayed by the user equipment, and evaluated by a user. The user equipment may include all of the hardware and/or software described in FIG. 20, including a processor, a memory, and/or a transceiver.

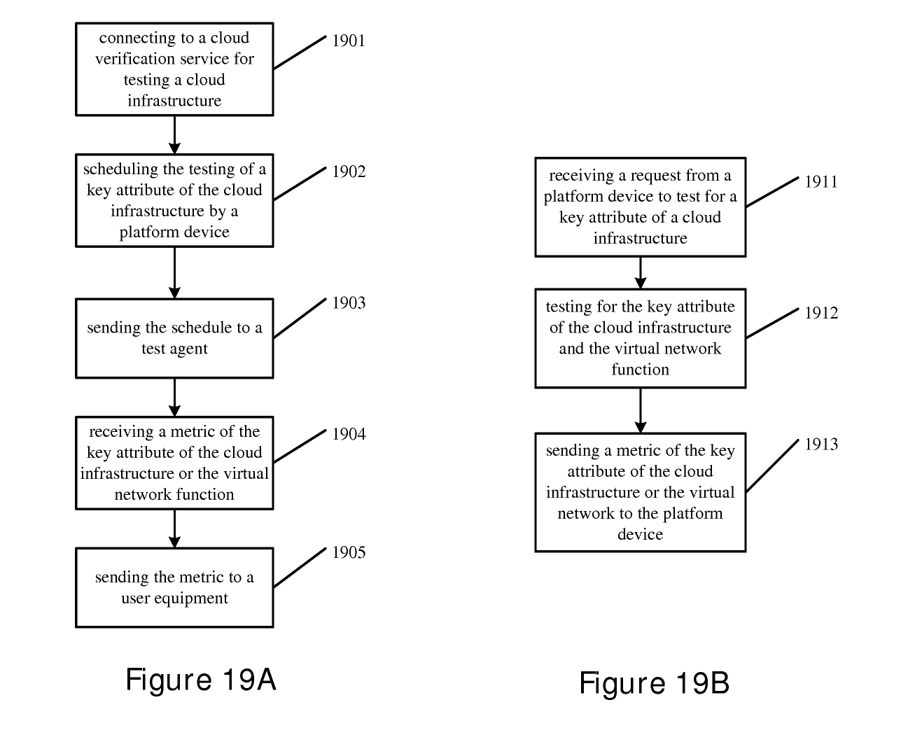

FIG. 19A illustrates a flow diagram according to certain embodiments. Specifically, FIG. 19A illustrates a flow diagram according to a platform device. Step 1901 includes connecting to a cloud verification service for testing a cloud infrastructure. In step 1902, the platform device can schedule the test of a key attribute of the cloud infrastructure. A virtual network function may be executed on the cloud infrastructure. In step 1903, the schedule may be sent from the platform device to a test agent. Once a test agent begins testing, the platform device may receive metrics of the key attribute of the cloud infrastructure or the virtual network function, as shown in step 1904. The platform device can send the metrics to a user equipment, which may display the metric on a user interface.

FIG. 19B illustrates a flow diagram according to certain embodiments. Specifically, FIG. 19b illustrates a flow diagram according to a test agent. The test agent receives a request from a platform device to test for a key attribute of a cloud infrastructure, as shown in step 1911. In step 1912, the test agent can test for the key attribute of the cloud infrastructure and the virtual network function. The test agent may then send a metric of the key attribute of the cloud infrastructure or the virtual network to the platform device, as shown in step 1913.

FIG. 20 illustrates a system according to certain embodiments. It should be understood that each block of the flowchart of FIGS. 1-18, 19A, and 19B, and any combination thereof, may be implemented by various means or their combinations, such as hardware, software, firmware, one or more processors and/or circuitry. In one embodiment, a system may include several devices, such as, for example, a platform device 2010 and a test agent device 2020. The platform device may be a scheduler, collector, orchestrator, analyzer and reporter, final report generator, or a user interface. The test agent device, for example, may be a reporter, logger, or pluggable executor.

Each of these devices may include at least one processor or control unit or module, respectively indicated as 2021 and 2011. At least one memory may be provided in each device, and indicated as 2022 and 2012, respectively. The memory may include computer program instructions or computer code contained therein. One or more transceiver 2023 and 2013 may be provided, and each device may also include an antenna, respectively illustrated as 2024 and 2014. Although only one antenna each is shown, many antennas and multiple antenna elements may be provided to each of the devices. Other configurations of these devices, for example, may be provided. For example, platform device 2010 and test agent device 2020 may be additionally configured for wired communication, in addition to wireless communication, and in such a case antennas 2024 and 2014 may illustrate any form of communication hardware, without being limited to merely an antenna.

Transceivers 2023 and 2013 may each, independently, be a transmitter, a receiver, or both a transmitter and a receiver, or a unit or device that may be configured both for transmission and reception. The operations and functionalities may be performed in different entities. One or more functionalities may also be implemented as virtual application(s) in software that can run on a server.

The user interface may be located on a user device or user equipment such as a mobile phone or smart phone or multimedia device, a computer, such as a tablet, provided with wireless communication capabilities, personal data or digital assistant (PDA) provided with wireless communication capabilities or any combinations thereof. The user equipment may also include at least a processor, a memory, and a transceiver.

In some embodiment, an apparatus, such as a node or user device, may include means for carrying out embodiments described above in relation to FIGS. 1-18, 19A, and 19B. In certain embodiments, at least one memory including computer program code can be configured to, with the at least one processor, cause the apparatus at least to perform any of the processes described herein.

Processors 2011 and 2021 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 2012 and 2022 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as platform device 2010 and/or test agent device 2020, to perform any of the respective processes described above (see, for example, FIGS. 1-18, 19A, and 19B). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments may be performed entirely in hardware.

The above embodiments allow for testing of a telecommunications software application in a cloud infrastructure. The testing may be used to verify the underlying cloud infrastructure on behalf of the cloud applications, such as virtual network functions, in a fully automated and systematic function. The above embodiments may also deploy a distributed architecture with test and monitor agents, across many computing nodes in the cloud under test. These agents can approximate the behavior of cloud applications as deployed in the real world, and may test key attributes of underlying computing, network, and storage capabilities.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### PARTIAL GLOSSARY

RAN radio access network

IP internet protocol

TCP transmission control protocol

UDP user datagram protocol

SCTP stream control transmission protocol

KPIs key performance indicators

CSCF call session control function

IMS IP multimedia system

REST representational state transfer

API application program interface

UI user interface

HBeat heartbeat

VNF virtualized network function

VPN virtual private network

JSON javascript object notation

1.-21. (canceled)

22. A method comprising:
connecting to a cloud verification service for testing a cloud infrastructure;
triggering execution of a virtual network function on the cloud infrastructure, wherein a key attribute of the cloud infrastructure is tested with the executed virtual network function using the cloud verification service; and
receiving a metric of the key attribute of the cloud infrastructure or the virtual network function at a user equipment.

23. The method according to claim 22, wherein the metric of the key attribute of the cloud infrastructure or the virtual network function may be compared to a reference key attribute or virtual network function that was previously tested, wherein the reference key attribute may be from the same cloud or from a different cloud.

24. The method according to claim 22, wherein the metric may involve the testing if the network infrastructure or the virtual network function using at least one of a transmission control protocol, a user datagram protocol, or a stream control transmission protocol.

25. The method according to claim 22, further comprising:
displaying the metric on a user interface of the user equipment.

26. The method according to claim 22, wherein a distributed architecture is used during the testing of the key attribute of the cloud infrastructure or the virtual network function.

27. The method according to claim 22, further comprising:
monitoring the testing of the key attribute in at least two computing nodes in the cloud infrastructure.

28. The method according to claim 22, wherein the key attributes may include at least one of computing, networking, storage, or service capabilities of the cloud infrastructure.

29. The method according to claim 22, wherein the testing may include evaluating different network paths or topology inside the cloud.

30. The method according to claim 22, wherein the metric may include a grade for comparing the key attribute to a reference cloud infrastructure.

31. The method according to claim 22, further comprising:
receiving a generated report of the metric; and
displaying the report at the user equipment.

32. A method comprising:
connecting to a cloud verification service for testing a cloud infrastructure; and
scheduling a testing of a key attribute of the cloud infrastructure by a platform device, wherein a virtual network function may be executed on the cloud infrastructure;
sending the scheduling to a test agent; and
receiving a metric of the key attribute of the cloud infrastructure or the virtual network function.

33. The method according to claim 32, further comprising:
sending the metric to a user equipment.

34. The method according to claim 32, further comprising:
storing the metric in a database.

35. The method according to claim 32, further comprising:
monitoring the progress of the testing of the key attribute of the cloud infrastructure or the virtual network function.

36. A method comprising:
receiving a request from a platform device to test for a key attribute of a cloud infrastructure, wherein a virtual network function may be executed on the cloud infrastructure;
testing for the key attribute of the cloud infrastructure and the virtual network function; and
sending a metric of the key attribute of the cloud infrastructure or the virtual network function to the platform device.

37. The method according to claim 36, further comprising:
using a plugin to perform the testing.

38. The method according to claim 36, further comprising:
sending to the platform device a heartbeat, wherein the heartbeat informs the platform device that the test agent is ready for testing the cloud infrastructure.

39. An apparatus comprising:
at least one memory comprising computer program code; and
at least one processor;
wherein the at least one memory and the computer program code are configured, with the at least one processor, to cause the apparatus at least to perform a process according to claim 22.

40. An apparatus comprising means for performing a process according to claim 32.

41. A non-transitory computer-readable medium encoding instructions that, when executed in hardware, perform a process according to claim 22.
